(19) United States
(12) Patent Application Publication
(10) Pub. No.: US 2022/0414904 A1
(43) Pub. Date: Dec. 29, 2022

(54) METHOD OF COMPENSATING FOR SHRINKAGE AND DISTORTION USING SCANS

(71) Applicant: Desktop Metal, Inc., Burlington, MA (US)

(72) Inventor: Andrew Fiske Roberts, Chelsea, MA (US)

(73) Assignee: Desktop Metal, Inc., Burlington, MA (US)

(21) Appl. No.: 17/898,309

(22) Filed: Aug. 29, 2022

Related U.S. Application Data
(63) Continuation-in-part of application No. 16/880,319, filed on May 21, 2020.
(60) Provisional application No. 62/902,189, filed on Sep. 18, 2019.
(60) Provisional application No. 62/850,957, filed on May 21, 2019.

(51) Int. Cl. G06T 7/33; G06T 17/20; G06T 7/37

(52) U.S. Cl. CPC G06T 7/344; G06T 17/205; G06T 7/37; G06T 2207/10081

(57) ABSTRACT

A method of compensating for shrinking and distortion of an object resulting from a manufacturing process. A scan is performed of an object following a manufacturing process to produce scan data. The scan data is aligned to a part mesh of the object. The part mesh is adjusted to substantially coincide with the scan data by moving part mesh vertices. Delta vectors are computed by subtracting initial part mesh vertex positions from final part mesh vertex positions. The inverse of the delta vectors are applied to the preprocessed part mesh to give a scan adjusted pre-processed shape.

The present application is a Continuation-in-Part of U.S. patent application Ser. No. 16/880,319, filed on May 21, 2020, and claims the benefit of U.S. Provisional Application No. 62/850,957, filed on May 21, 2019 and U.S. Provisional Application No. 62/902,189, filed on Sep. 18, 2019. The entire teachings of the above applications are incorporated herein by reference.

### TECHNICAL FIELD

Various aspects of the present invention relate generally to systems and methods for distortion compensation for 3D printing.

### BACKGROUND OF THE DISCLOSURE

Mechanical processes used to print and sinter metal parts may cause multiple geometric distortions to take place upon the material. For example, parts that are 3D printed and sintered undergo shrinkage, warping, cracking, and slumping. Parts that are laser printed (e.g., using Selective Laser Melting and Direct Metal Laser Sintering) may also undergo geometric distortions. Parts that manufactured using metal injection molding (i.e. MIM) may also undergo geometric distortions.

To account for these geometric distortions, engineers may attempt to guess at dimensional corrections, and geometry additions (e.g., supports) and apply them to the manufactured parts in order to achieve a post processed result that approaches near net shape of the designed parts. As an example, an engineer may anticipate that a part will experience slumping in a sintering process and thus create a part design including a distortion in one direction, such that the 3D printed resultant part may be near the desired shape after slumping. These engineer designed approaches may use only “as-measured” data points from scans or photographs. The resulting corrections—usually negative offsets—may thus be haphazard and inaccurate, both because they are manual and because they are based on the final result, with no knowledge of the time-based process that achieves these results.

A desire exists for a way to provide mechanical designs and manufacturing solutions that result in desired geometries. The following invention is directed to systems and methods for addressing this need for designing and manufacturing parts while accounting for geometric distortions that may occur during manufacturing or post-processing.

### SUMMARY OF THE DISCLOSURE

In exemplary embodiments, a non-transitory, computer-readable medium for use on a computer system containing computer-executable programming instructions for performing a distortion simulation can perform methods for distortion compensation and/or methods for additive manufacturing and metal injection molding manufacturing.

The method can include receiving a model of a part used in at least one of additive manufacturing or metal injection molding manufacturing; generating a cell mesh using the received model of the part; and/or performing a simulation on the cell mesh undergoing one or more mechanical processes.

In at least some embodiments, the simulation can include an input parameter representing at least one of a mechanical property of the part, a coefficient associated with the one or more mechanical processes, or a combination thereof and/or generating, based on the simulation, a distorted cell mesh.

In exemplary embodiments, the method can also include receiving a scan of a physical part generated from the one or more mechanical processes; defining a set of rotation axes comprising at least a first rotation axis and a second rotation axis; defining an axis of the set of rotation axes as at least two increments; computing rotational deviation for the at least two increments; identifying, of the computed rotational deviation for the at least two increments, the lowest computed rotational deviation; identifying one or more axes of the set of rotation axes associated with the identified lowest computed rotational deviation; aligning the scan of the physical part mesh to the cell mesh based on the identified one or more axes; and computing, based on the aligned scan of the physical part mesh, a deviation score by comparing the distorted cell mesh to the scan of a physical part generated from the one or more mechanical processes.

In exemplary embodiments, the deviation score can be the average of the deviations between vertices of distorted cell mesh and nearest points on scan of physical part.

In exemplary embodiments, the method can include running a distortion simulation using input parameter values including at least one of shrinkage rate, coefficients of friction, creep strain stress threshold, and material compliance; iterating the running of the distortion simulation by incrementing values of input parameters; and/or generating the deviation score for each step corresponding to those input parameter values.

In exemplary embodiments, the method can include repeating the distortion simulation by incrementing the input parameter values; selecting the input parameter values corresponding to the minimum deviation score and identifying the corresponding input parameter values as the tuning result; and/or generating a negative offset for the model of the part from the tuning result.

In exemplary embodiments, the generating a negative offset for the model of the part from the tuning result can include performing a first distortion simulation on initial cell mesh to produce a first distorted cell mesh using parameter values from the tuning result; initializing a map of aggregate distortion vectors corresponding to vertices in initial cell mesh; computing values for first distortion vectors where each first distortion vector is the difference between the position of a first distorted cell mesh vertex and the corresponding position of the initial cell mesh vertex; updating the map of aggregate distortion vectors by applying one or more first distortion vectors; adding distortion vectors from map of aggregate distortion vectors to positions in initial cell mesh to create first updated cell mesh; performing the distortion simulation on first updated cell mesh to produce a second distorted cell mesh; computing values for second distortion vectors, wherein each second distortion vector is the difference between the position of a second distorted cell mesh vertex and the corresponding position of the initial cell mesh vertex; updating the map of aggregate distortion vectors by applying one or more second distortion vectors; and adding distortion vectors from map of aggregate distortion vectors to positions in first updated cell mesh to create second updated cell mesh.

In exemplary embodiments, the method can include repeating the steps of performing a distortion simulation on Nth updated cell mesh to produce a Nth+1 distorted cell mesh and updated map of aggregate distortion vectors; and stopping the repeating of steps when the deviation between positions of vertices in Nth+1 distorted cell mesh and positions of vertices in the initial cell mesh is within a tolerance of plus or minus (+/−) 1%.

In exemplary embodiments, the updated aggregated distortion vectors can be applied to a generated triangle mesh.

In exemplary embodiments, the triangle mesh generation can include defining a vector function on the triangle mesh based on the updated map of aggregate distortion vectors; and generating a distortion mesh based on the vector function and the updated map of aggregate distortion vectors.

Disclosed further are methods of utilizing scans of post-process shapes to modify the design of pre-process shapes. The modification process is called “scan adjustment.” Scan adjustment may be applied to pre-process shape parts that have been generated via linear scale up, or negative offset compensation scale up. A scan of a previously generated (i.e. first run) post-process part maybe compared using software with a design shape. This comparison may be called a deviation analysis and the result may be called a deviation mapping. A deviation mapping may define the distortion vectors that describe the shift and change in orientation of the exterior surface in the region of each point on the post-processed (e.g. sintered) shape, with respect to the corresponding point on the design shape.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a block diagram of an exemplary system and network for determining and correcting mechanical distortion while manufacturing parts, according to an exemplary embodiment of the present invention.

FIGS. 2A and 2B depict a test sample rod and its mechanical distortion, according to an exemplary embodiment of the present invention.

FIGS. 3A-3H depict sintering distortion simulation user interfaces, according to an exemplary embodiment of the present invention.

FIG. 4 is a flowchart of an embodiment of simulating and predicting a mechanical distortion, according to an exemplary embodiment of the present invention.

FIG. 5A is a schematic diagram of a neural network for tuning the distortion simulation, according to an exemplary embodiment of the present invention.

FIG. 5B is a flowchart of an embodiment of tuning the distortion simulation, according to an exemplary embodiment of the present invention.

FIG. 6 is a diagram and flowchart of an embodiment of generating a part correction, according to an exemplary embodiment of the present invention.

FIGS. 7A-7C depict transformation simulation user interfaces with part corrections, according to an exemplary embodiment of the present invention.

FIGS. 8 and 9 are flowcharts of methods of auto-positioning scanned compare zone meshes, according to an exemplary embodiment of the present invention.

FIG. 10 is a flowchart of a method of generating negative distortion vectors, according to an exemplary embodiment of the present invention.

FIG. 11 is a flowchart of a method of creating a negative distortion mesh from negatively distorted cell mesh positions, according to an exemplary embodiment of the present invention.

FIG. 12 depicts models, meshes, and vector fields used in creating a negative distortion mesh from negatively distorted cell mesh positions, according to an exemplary embodiment of the present invention.

FIG. 13 depicts a method of developing a pre-process shape for manufacturing a final post-processing shape.

FIG. 14 depicts a first method of developing a pre-process shape that is pre-deformed for manufacturing a final post-processing shape better matching a design shape.

FIG. 15 depicts a second method of developing a pre-process shape that is pre-deformed for manufacturing a final post-processing shape better matching a design shape.

FIG. 16 depicts a third method of developing a pre-process shape that is pre-deformed for manufacturing a final post-processing shape better matching a design shape.

FIGS. 17A-D depict a method of handling scans where there is missing data.

FIGS. 18A-D depict a method of preservation of flatness in generating negative offset pre-process shapes.

FIGS. 19A-H depict an embodiment method of mesh registration.

### DETAILED DESCRIPTION

Reference will now be made in detail to the exemplary embodiments of the present invention, examples of which are illustrated in the accompanying drawings. Wherever possible, the same reference numbers will be used throughout the drawings to refer to the same or like parts.

As described above, engineers may manually account for distortions that may occur during part manufacturing and/or post-processing, but such manual adjustments may be unreliable, labor-intensive, and misguided. Accordingly, the present invention is directed to systems and methods for automatically generating mechanical part designs and manufacturing specifications/instructions that account for geometric distortions that may occur during manufacturing or post-processing.

One drawback with existing methods of pre-distorting parts to achieve better results is that they simply observe a final distortion and aim to adjust a part based on the final distortion. However, distortions may be attributable to several processes performed while manufacturing a part. The disclosed systems and methods recognize the need for an accurate simulation of the many mechanical processes involved in producing a physical form of a designed mechanical part. In particular, the disclosed systems and methods are directed to creating complex simulations that are time-dependent and non-linear, and based on multiple physical phenomenon.

In other words, if one simply observes the final distortion caused by an actual mechanical process, such as sintering, and applies a simplistic negative distortion to the original CAD part (or other model part) by the negative of the amount that it shrank and sagged, the result may be a part that distorts close to the desired shape, but does not match the desired shape. The reason is that a negatively distorted part will behave in a new way. For example, if a beam distorts to a sagged shape with sintering, and one simply distorts the beam upwards by the same amount that it sagged, the result of sintering the upward arched beam may still be a curved beam. The negatively distorted arch may not sag at all, or the arch shape may provide some stability that prevents it from distorting into a flat beam. The current embodiments recognize the need to provide an accurate simulation of the mechanical transform process, measure the delta in the results to the desired shape, and iteratively apply a negative transformation in a compounding way to the original part and subsequently negatively distorted parts. If the simulation is close but not exact, the current embodiments include an iterative approach that may repeatedly apply compounded transforms to the original shape, and thus result in a simulated result that matches actual mechanical transformation results. Further, even if an iterative approach is taken, the incremental modifications may be informed based on simulated parameters as opposed to based on trial- and error observations of outcomes. In this way, the disclosed systems and methods may provide accuracy in sintering (or performing any process on) parts, which may be critical to the usefulness of the final mechanical parts.

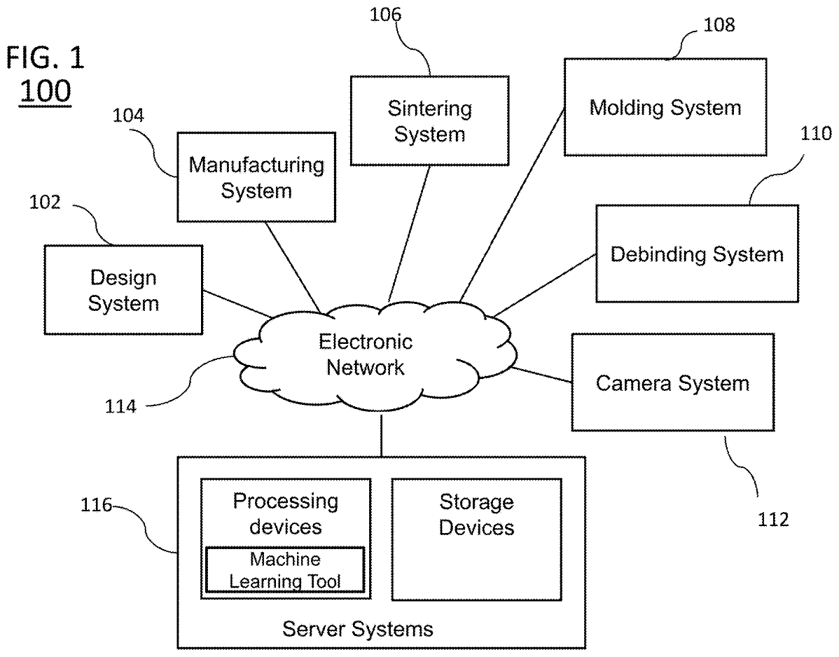

Referring now to the figures, FIG. 1 depicts a block diagram of an exemplary system 100 environment of a system and network for determining and correcting mechanical distortion while manufacturing parts, using machine learning. Specifically, system 100 may include various processors or platforms (e.g., design system 102, manufacturing system 104, sintering system 106, molding system 108, debinding system 110, camera system 112) and at least one network 114. It will be understood, however, that the specific components of system 100 may be altered, e.g., based on the type of part being produced, the type of manufacturing system and/or post-processing system being used, the location in which the manufacturing is taking place, etc. Manufacturing system 104 may include an additive or 3D printing manufacturing system, including, e.g., a metal printing system. The various processors or platforms may be connected to network 114 and may communicate via network 114. Network 114 may be comprised of one or more of a wireless network (employing, for example, wireless fidelity (Wi-Fi) or satellite), a data network (e.g., a local area network (LAN), metropolitan area network (MAN), wide area network (WAN), the Internet, any packet-switched network, etc.), a private network, a public network, a cable network, etc.

Server systems 116 may include storage devices for storing images and data received from at least one of the various processors or platforms. Server systems 116 may also include processing devices for processing images and data stored in the storage devices. Server systems 116 may further include one or more machine learning tool(s) or capabilities, e.g., due to the processing devices. Alternatively or in addition, the present invention (or portions of the system and methods of the present invention) may be performed on a local processing device (e.g., a laptop), absent an external server or network. While FIG. 1 illustrates an embodiment in which the various processors or platforms communicate with one another and server systems 116 via network 114, alternative embodiments may include the various processors or platforms connecting directly to, or being part of, at least one other processor/platform.

System 100 may comprise a software system for geometrically compensating the shape of a part and optional supporting structures in order to account for distortion due to time-based mechanical process transformations. System 100 may help achieve formation of a part that has a desired, undistorted shape. To do so, system 100 may employ a tuning phase and an application phase. The tuning phase may be applied to test or sample parts. The tuning phase may employ a neural network combined with a time-based multi-physics engine to simulate and tune simulated mechanical distortions Once system 100 has tuned a mechanical simulation using actual sample part results (that may be digitally scanned), the application phase may be initiated. For example, system 100 may provide a means of adaptively predicting negative pre-distortions to any number of input design parts in order to correct for undesired distortions using the same mechanical process, e.g., an iterative self-adaptive part correcting mechanism. Using an adaptive iterative approach, for example, system 100 may simulate a distortion, apply a negative pre-distortion, and run the simulation again while applying a next compounded negative-distortion. In one embodiment, the iterative simulation process may be repeated until the simulated result erases all, or a threshold number of, undesired distortions caused by the mechanical process. The result of the application phase may include a design, model, or manufacturing specification(s) comprising a pre-distorted part, support structure(s), or a combination thereof, that will produce desired results when the actual mechanical processes are applied to parts manufactured according to the pre-distorted data. The output of system 100 may include a set of pre-distorted files used in downstream manufacturing.

Examples of mechanical processes that apply geometric distortions include 3D printing, sintering, metal injection molding, chemical debinding, and thermal debinding. The tuning and application phases of system 100 account for one or more of characteristics of these mechanical processes, or other mechanical processes not listed, including creep strain, phase changes of elastic to plastic deformation, friction drag, time-based shrinkage and densification, Poisson Effect of compressibility of hot materials, collisions with rigid structures, and/or responses to body forces such as gravity, surface tension, and tearing thresholds for simulating cracks A subset of these processes may be activated in a system 100 simulation. As an example, when bound powder metal parts are sintered, they may undergo transformation distortions in the form of creep strain, shrinkage, frictional drag, and/or cracking that result in shapes that fail to match desired dimensional accuracy of parts prior to mechanical transformations. Other forms of part construction include Fused Deposition Modeling (FDM), or Fused Filament Fabrication (FFF) of MIM powders, injection molding of MIM powders. Other mechanical transformations include thermal and chemical debinding and sintering.

System 100 may comprise a software module that simulates numerous distortions that are a function of time, temperature, and other environmental factors. These simulated processes may take place, or compound, over time and are not static snapshots similar to what is obtained with simulations such as linear, elastic finite element analysis.

System 100 may further comprise one or more components for scanning/imaging (e.g., one or more of a laser scanner, camera, coordinate measuring machine, touch probe, etc.) actual samples of transformed or printed parts (made of, e.g., metal, plastic, etc.), and comparing the actual scanned/imaged samples with the simulated distorted results to obtain a number of fitness scores A fitness score may represent the accuracy of a simulated distorted part to an actual distorted part. An example of fitness includes overall distortion of external part mesh vertices (e.g., a heat map).

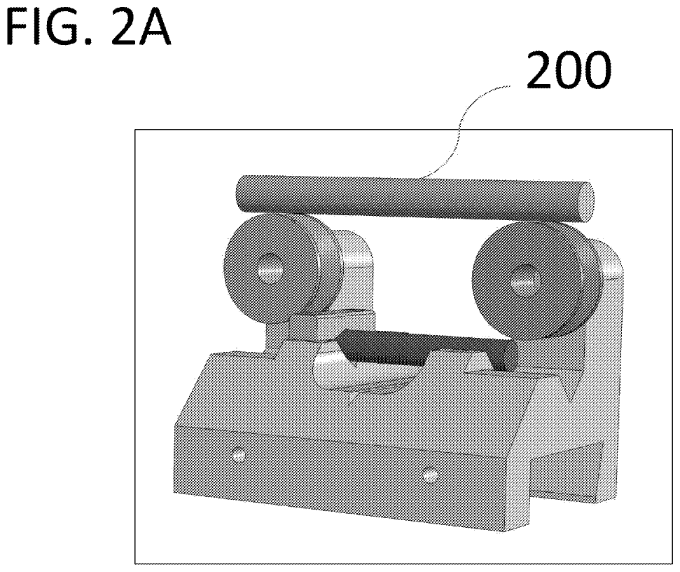

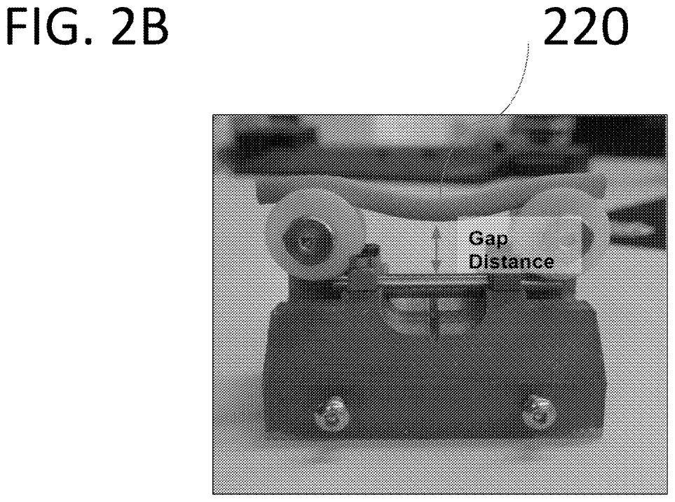

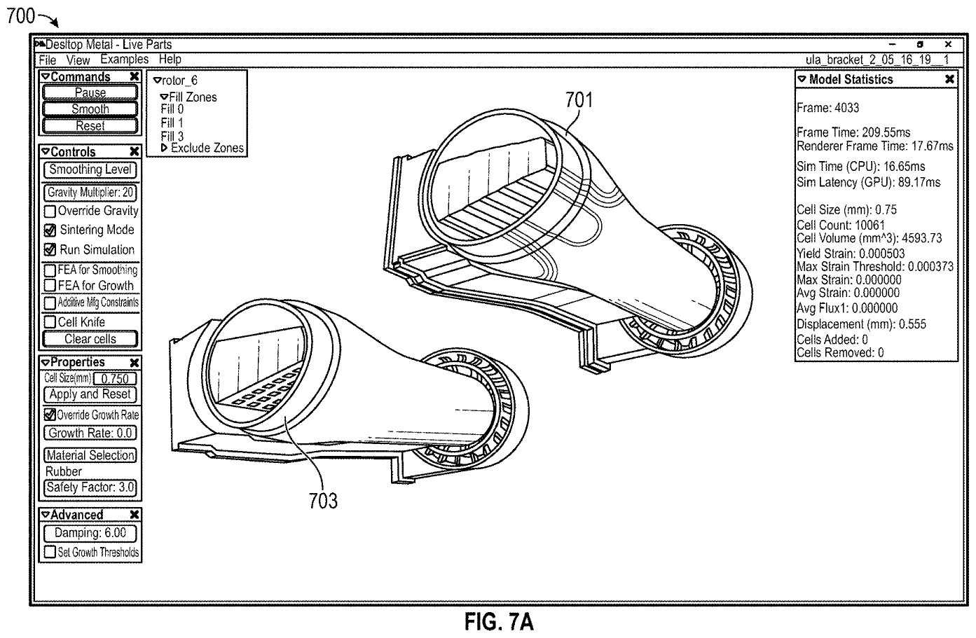

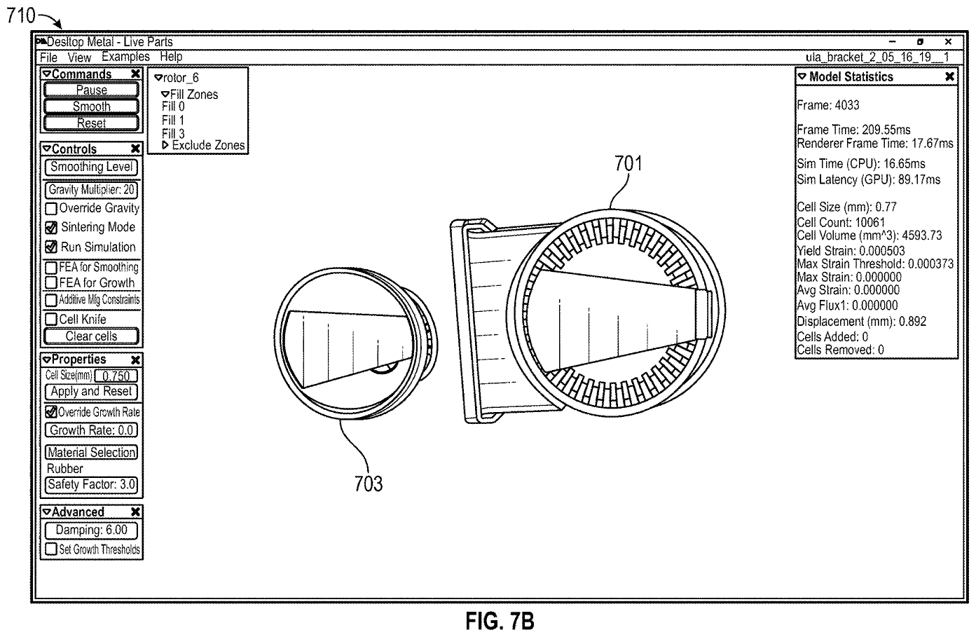

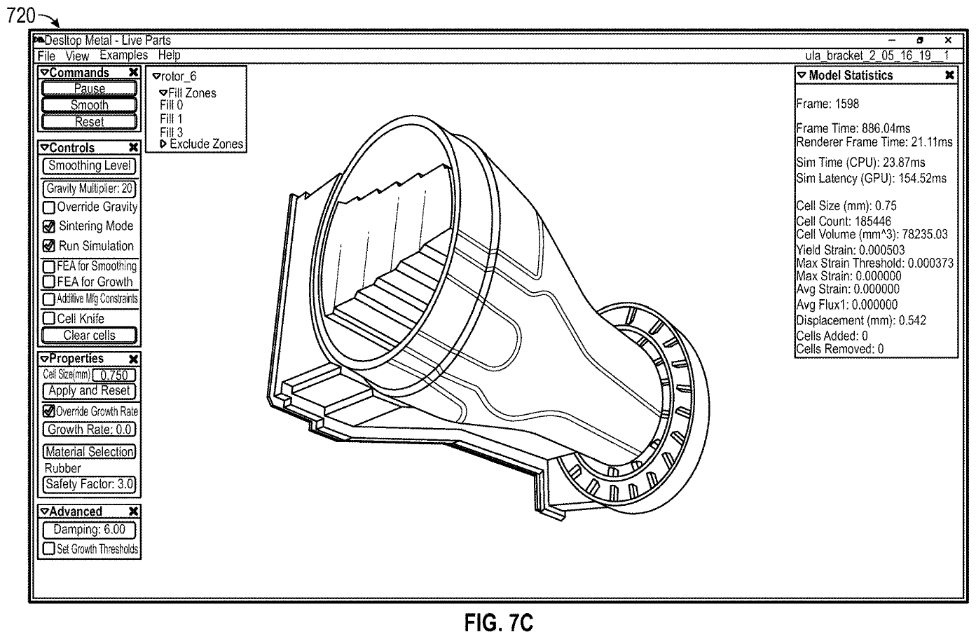

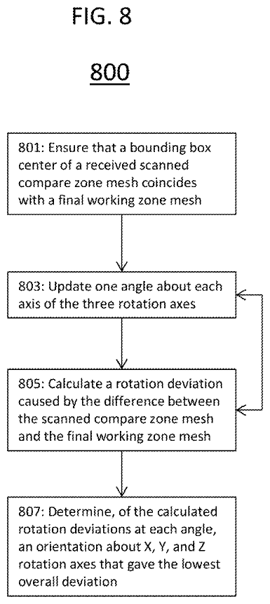

System 100 may determine and correct mechanical distortion using a variety of approaches, machine learning algorithms, simulations, and computations. The following invention describes various capabilities and functions of system 100. First, system 100 may provide a multi-physics mechanical distortion simulation, e.g., as described by FIGS. 2A-4 FIGS. 7A-7C show exemplary user interfaces and physical results of such a simulation. The multi-physics mechanical distortion simulation may provide a simulation of geometric distortions that may occur to a part, for example, during the manufacturing of a part. Such geometric distortions may occur during a printing process, sintering, post-processing, or any step taken to produce a final mechanical part. For example, one possible usage of system 100 would be to simulate mechanical transformations that take place during sintering. The multi-physics simulation may marry the combination of a time-based multi-physics simulation engine with linear elastic FEM engines (mechanical stress, heat dissipation), to accurately predict effects of mechanical processes. e.g., a part's plastic creep strain, shrinkage, friction drag, and/or elastic behavior. Simulations provided by system 100 may include GPU-based multi-physics, non-linear, or time dependent simulations, for example.

Making the manufacturing process simulation of system 100 may include an iterative training process. An initial step of an exemplary training process may include, for example, running a simulation that distorts the original mesh vertices to shrunken and deformed mesh vertices, and then checking the accuracy of the simulation by comparing the deformed mesh vertices to a scan of a physical part that was subjected to the real-life process that system 100 was set to simulate. As an example, the training process may include running a sintering simulation in which an original mesh may be subjected to one or more parameters and, as a result, may be distorted to a shrunken and deformed mesh. The shrunken mesh may represent the original mesh, post-simulation. The shrunken mesh may thus comprise a mesh of a simulated sintered part. The simulated sintered part mesh may then be compared to a scan of a physical sintered part, to check the accuracy of the sintering simulation. In other words, original mesh vertex transformations that are made to form the simulated sintered part mesh may be verified against actual transformations, provided by a scan of a physical part that has undergone sintering.

If discrepancies exist between the scan of the physical part (e.g., the sintered part) and the simulated sintered part mesh, the simulation may be adjusted, or tuned. The tuning may be performed manually, whereby a user observes the shape discrepancy between the simulation result and the scanned part, and decides to change one or more input parameters and rerun the simulation. As an example, a user may observe that the sides of part represented by the simulation result are more tipped inwards than the sides of the scanned part, and may determine that the friction coefficient of the part in the simulation against the furnace surface was too high, preventing the part from sliding inwards. Alternatively, the tuning may be performed by a neural network. The tuning may only be needed until the simulated sintered pan mesh matches the scan or matches the scan within a predetermined threshold level of acceptable difference. Once the tuning has been performed, the parameter values that generate simulated part meshes that match the scan of the physical part may be identified and set for use with future simulations. In this way, negative distortions may be created for new simulated part meshes without first tuning the simulation parameters using scans of these new part meshes. The tuning process applies to materials and print/mold manufacturing processes rather than each unique part geometry. As such, one may tune the simulation parameters for a material and process using a handful of representative part geometries. Once this is complete, one may run simulations on new part geometries using these parameter values. It is possible, however, to periodically tune the simulation after the initial tuning of the simulation environment has been performed.

A neural network may be incorporated into the process used to distort a part. For example, a simulation may distort an original mesh vertex to account for geometric changes that may occur during a manufacturing process. For instance, a distortion may include an enlarged, negatively distorted version of the original mesh vertex. The enlarged version may be designated as the “working mesh” This working mesh may be run through a sintering simulation, which should distort the enlarged working mesh to a shrunken, deformed, simulated sintered part mesh. The simulated sintered part mesh generated from the working mesh may be compared to the original (desired) part mesh. If the comparison indicates that discrepancies exist between the meshes, the working mesh may be altered to update the negative distortion applied to the working mesh, and the simulation may be nm again on the updated working mesh. Comparing of the simulated sintered part mesh to the original part mesh, updating the working mesh, and running the simulation, may be repeated until the simulated sintered part mesh generated from the working mesh matches the original part mesh within a given threshold, or until there is no difference. The neural network may be used to detect and anticipate parameter changes/distortions that should be made to a working mesh, to ensure that a post-manufacturing geometry reflects the original part mesh.

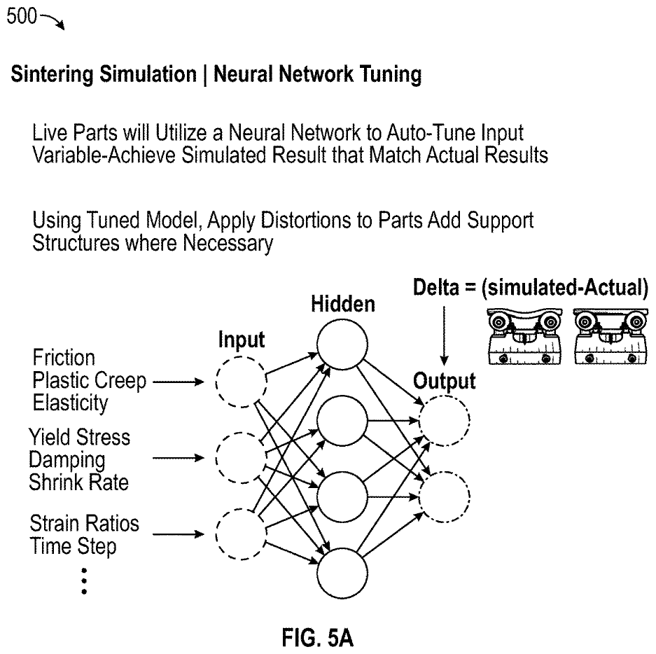

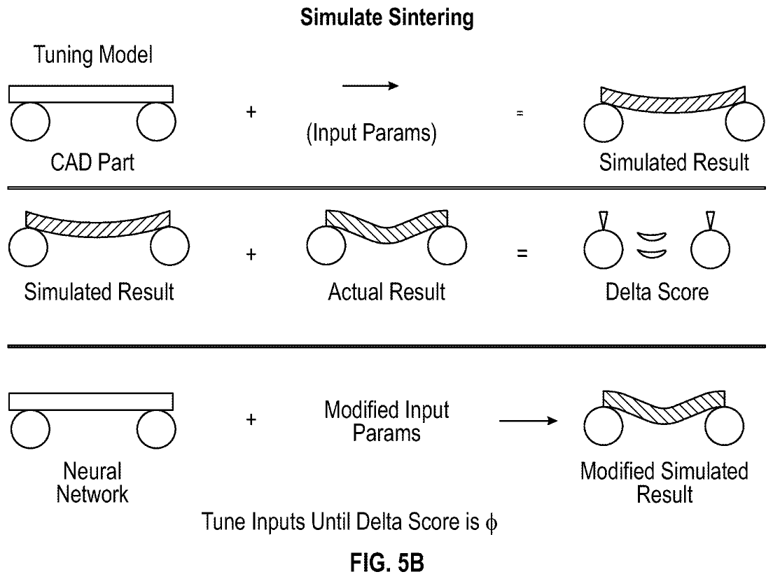

System 100 may also tune or train a simulation environment, in order to provide accurate simulations of the geometric distortions. For example, system 100 may use an approximation of many complex behaviors from predicted effects of mechanical processes to tune a simulation to obtain results that match actual test sample parts. The tuning of the simulation may involve employing a neural network, e.g., as described in FIGS. 5A and 5B The neural network may be paired with one or more cloud-based high speed simulation cores.

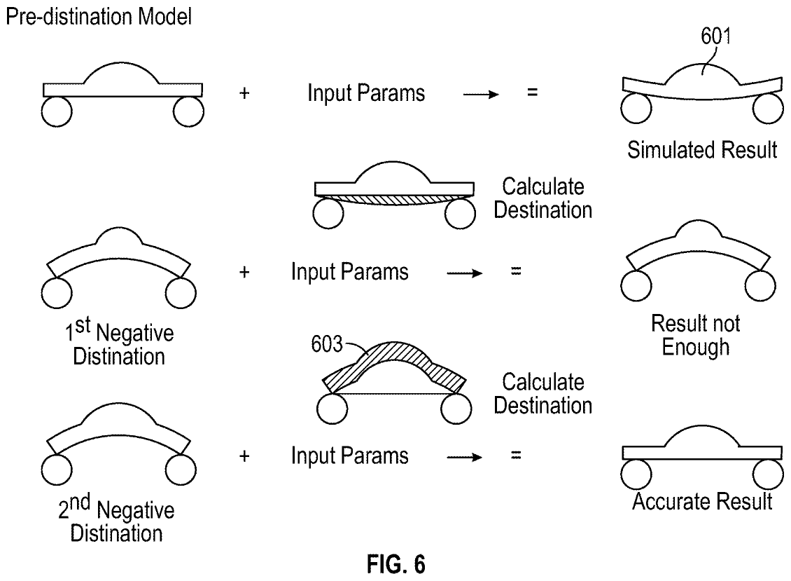

System 100 may further apply an adaptive iterative negative pre-distortion approach to generate design part shapes that will distort through simulation to give shapes that match desired design part input shapes. In other words, system 100 may tune distortion models based on actual/physical scanned parts. This approach is described in greater detail at FIGS. 6 and 7A-7C. Adaptively iterating via simulation may correct for excessive or insufficient negative distortions. In some embodiments, the goal of system 100 may be for a manufactured product to reach at least 90% of the desired net shape, or at least 95% of the desired net shape (for example, at least 97% or at least 98%) Furthermore, system 100 may use scanned/imaged 3D digital information to tune the already tuned model. The tuned simulation may be initially based on a number of sample test parts. In one embodiment, once the system 100 is being used to generate negative pre-distorted design parts, and once these parts are being manufactured, system 100 may use the manufactured parts as new data points to further tune the already tuned model. Below is a detailed description of each of these aspects of system 100.

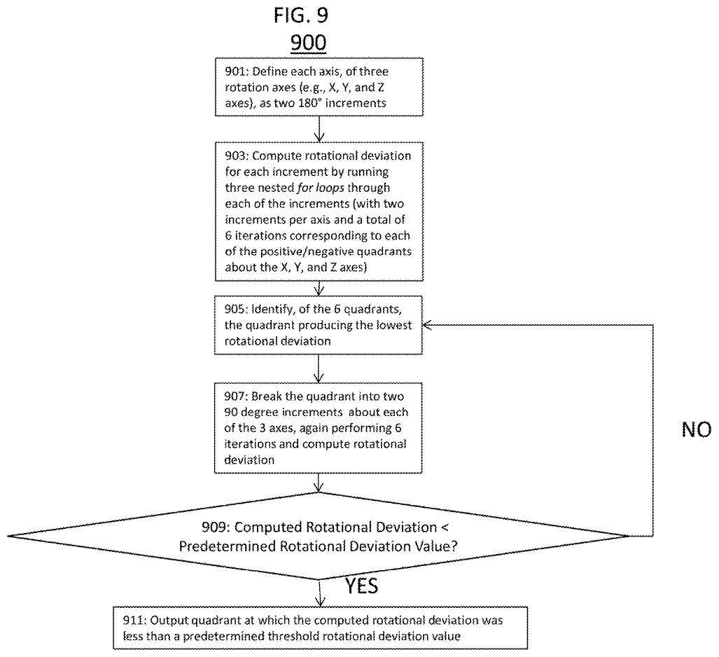

As part of checking or ensuring that the distortion corrections are correct, system 100 may use camera/scanner/measurement data acquisitions to fine-tune a tuned simulation model. Furthermore, system 100 may provide a way to compare a physical, mechanically processed part, to an original part mesh. For example, system 100 may provide an auto-positioning mechanism to facilitate this comparison (e.g., FIGS. 8 and 9). The auto-positioning may permit a way to quickly discern discrepancies between an original part mesh indicating a desired structure of the part, and a physical part that has undergone a manufacturing process.

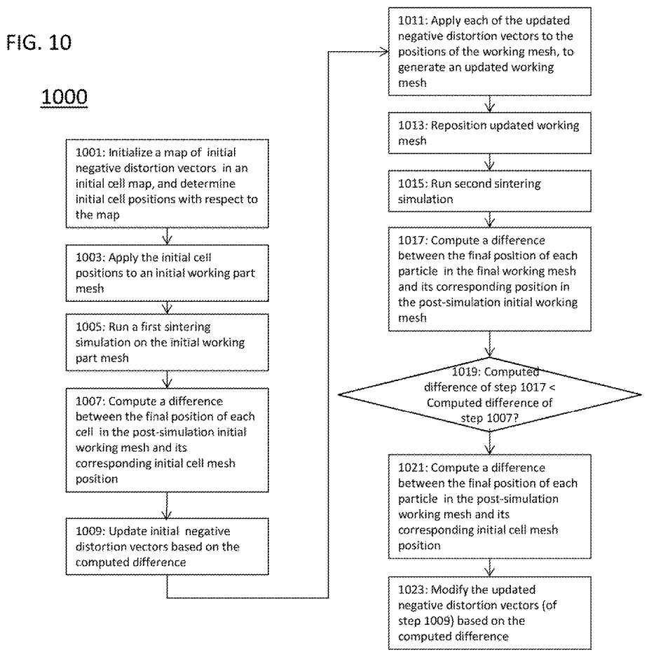

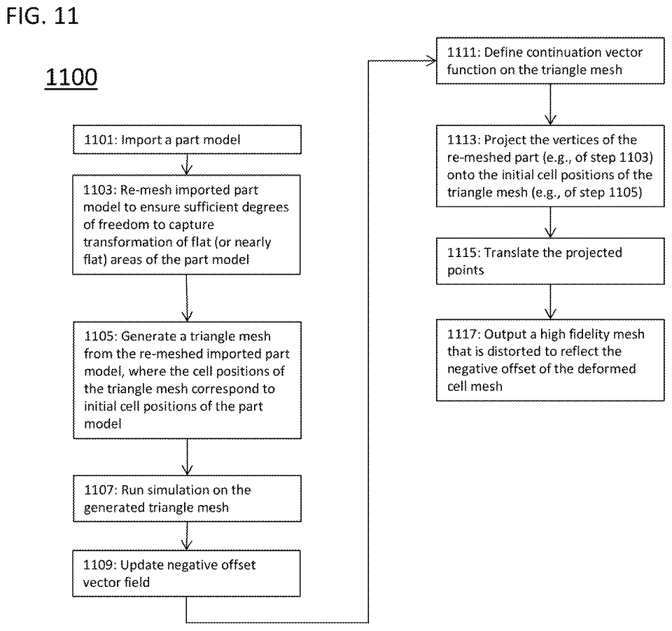

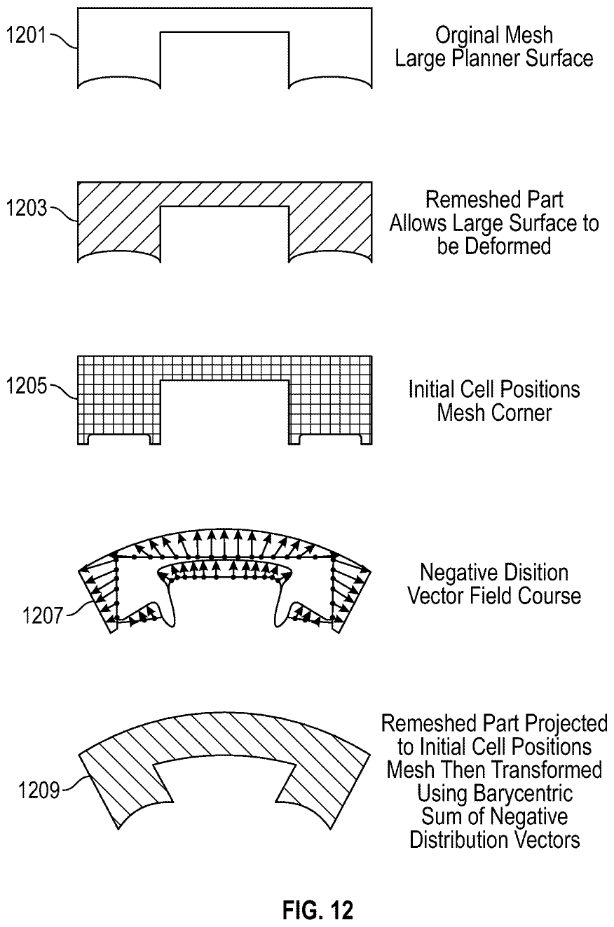

Throughout this invention, several references are made to distorting models/meshes and simulating distortions. As possible embodiments, the invention describes an exemplary method for iteratively generating negative distortion vectors (e.g., FIG. 10) and an exemplary method for creating distortion meshes (e.g., FIGS. 11 and 12).

Multi-Physics Mechanical Distortion Simulation

As previously described, system 100 may provide a mechanical distortion simulation environment. The simulation environment may use a multi-physics approach to provide a high speed time simulation of mechanical effects, such as shrinkage, creep deformation (e.g., plastic creep deformation), and friction drag. These simulations have coefficients that may be used to tune the behavior and outcome.

To illustrate, FIG. 2A depicts an exemplary CAD model 200 showing a test sample rod. Although CAD models are referenced herein for ease, it is understood that any suitable model type may be used within the context of this invention. In one embodiment, the CAD model 200 of the sample rod part may be loaded into system 100, or software comprising system 100. System 100 may simulate the distortion of the test sample rod of CAD model 200 due to a mechanical distortion process involving heat, time, and other factors that the sample rod part may be subjected to during manufacturing (e.g., during sintering, printing, debinding, or other mechanical processes). For example, FIG. 2B illustrates one such real-life distortion 220 that could be simulated by CAD model 200. Such real-life distortion 220 could be a result of sintering, printing, debinding, or other mechanical process(es) In one scenario, a distortion such as distortion 220 may be scanned/imaged to create a 3D digital model of actual transformed results.

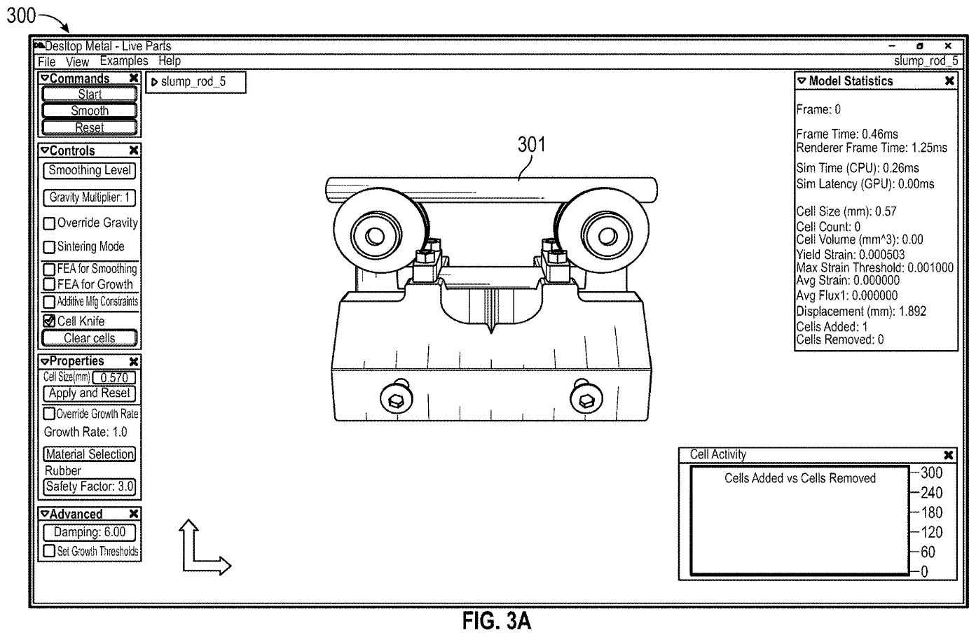

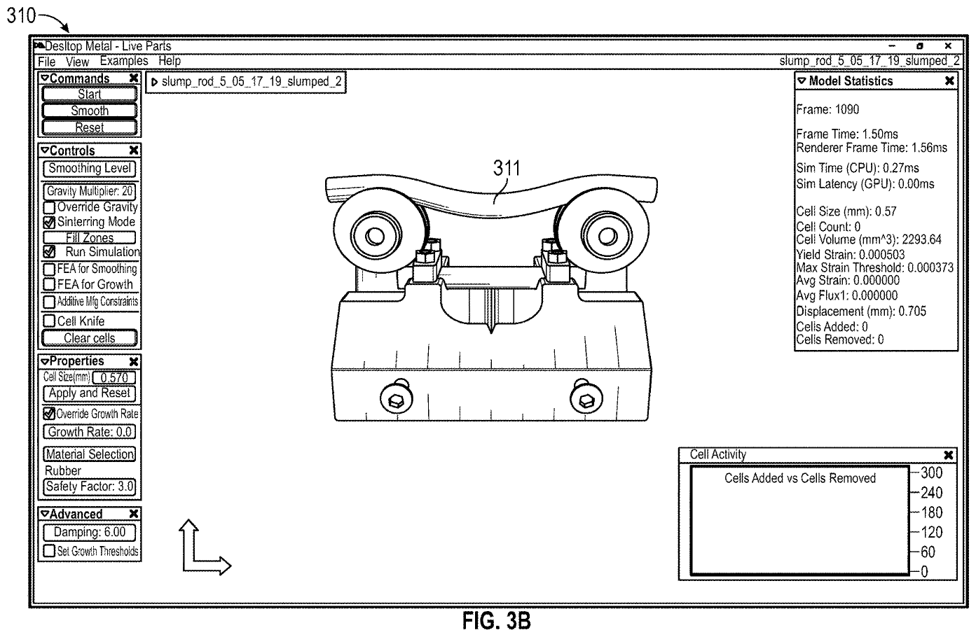

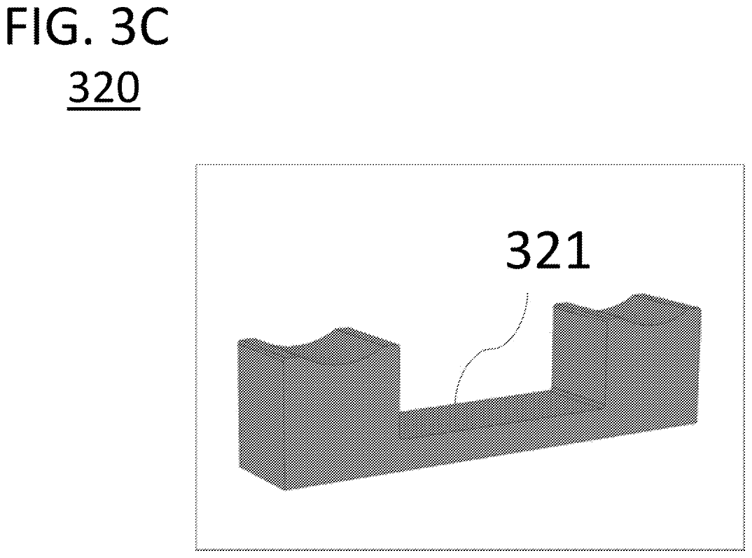

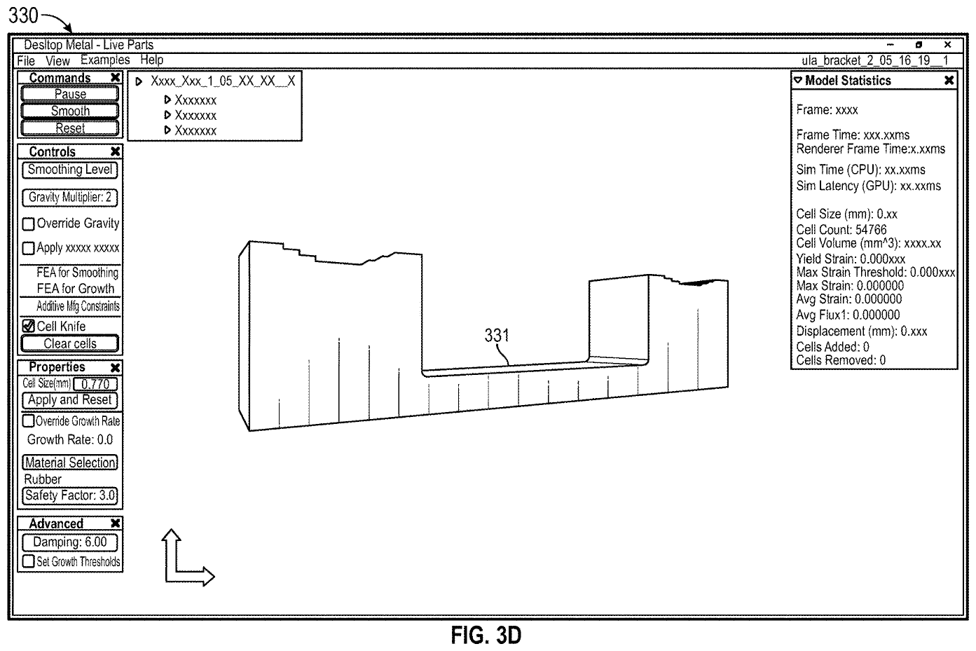

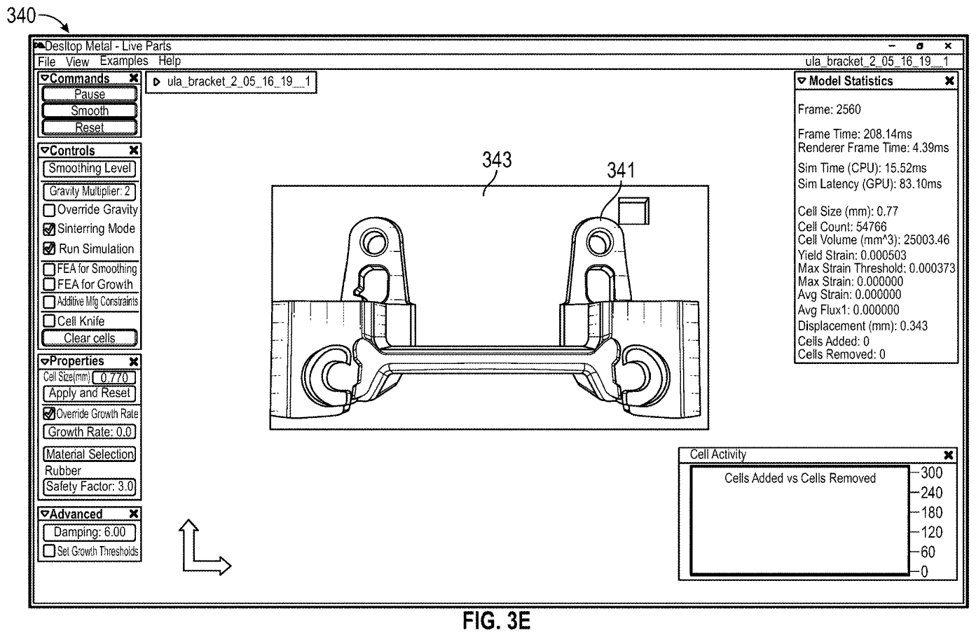

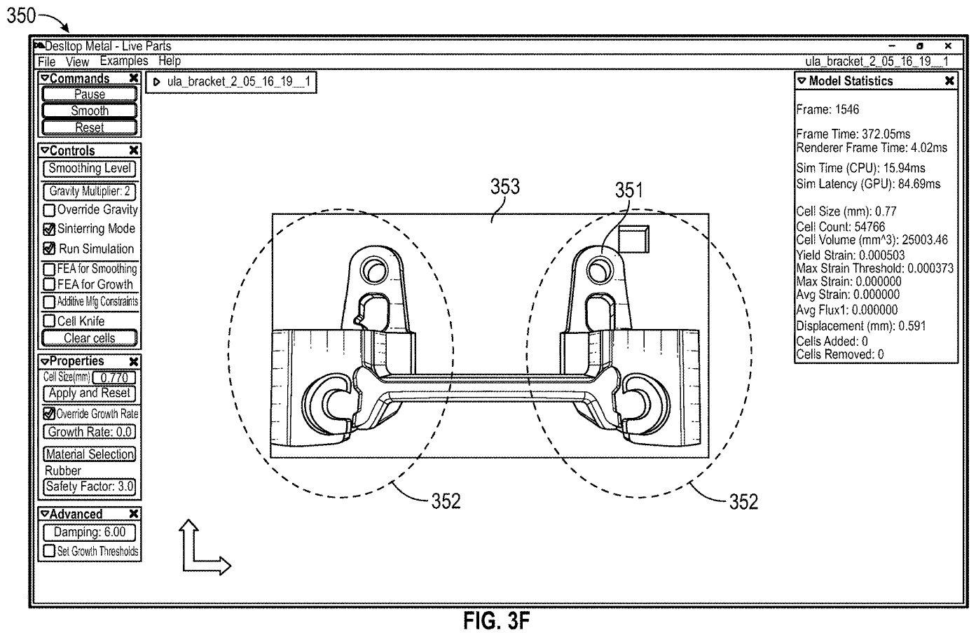

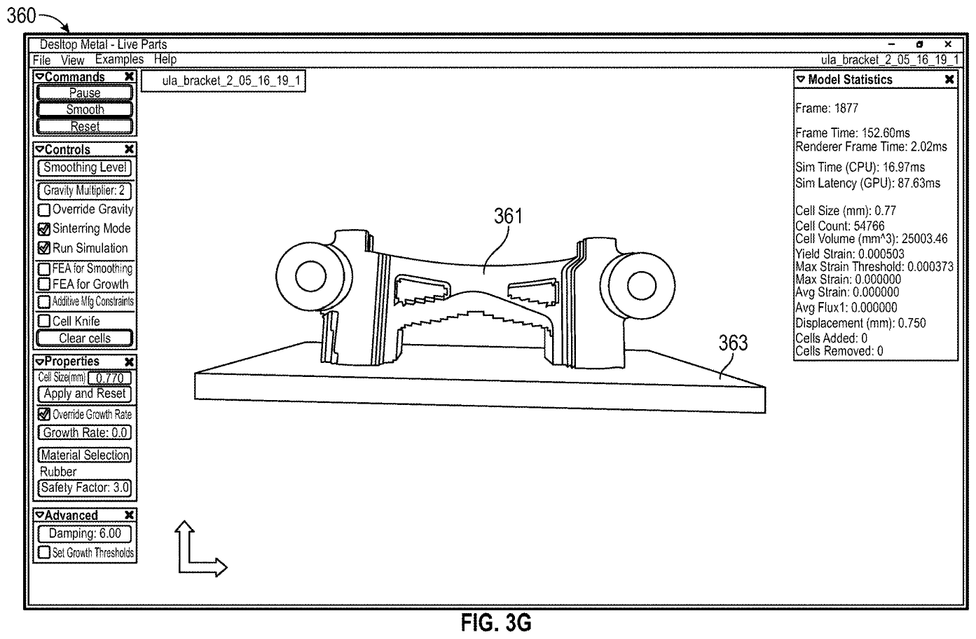

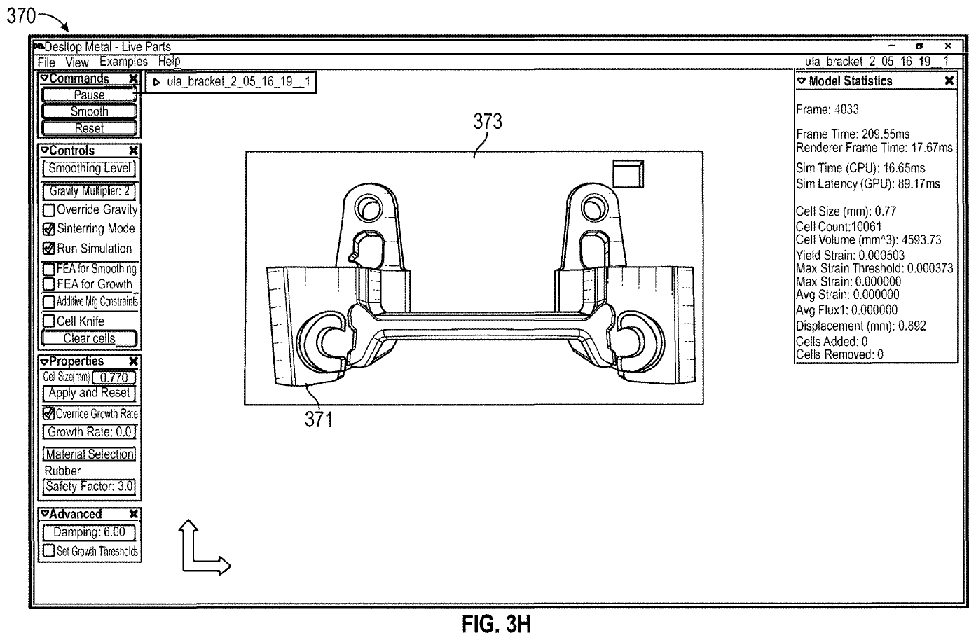

FIGS. 3A-3H depict exemplary distortion simulation user interfaces into which CAD models (or other suitable models) may be input/uploaded. For example, user interface 300 of FIG. 3A shows a CAD model 301 prior to a simulated distortion. User interface 310 of FIG. 3B shows a resultant CAD model 311 after running a time-based multi-physics simulation of slumping on the CAD model 301 of user interface 300 that subjected CAD model 301 to modeled physics parameters intended to simulate the forces that a part manufactured based on CAD model 301 would be subjected to during the manufacturing process. Such forces may occur from gravity, heat, compression, weight, etc. As shown by the Appendix, the simulation effects provided by system 100 may include the effects of compression-induced bulging, friction-induced drag and cracking, gravity or heat-induced slumping or stretching, etc. For example, system 100 may provide a high-speed simulation of varying compression based on the height of a material or part. In addition, system 100 may provide a high speed simulation of creep strain even on complex geometry. Similarly, user interface 320 of FIG. 3C shows a CAD model 321 prior to a simulated distortion, and user interface 330 of FIG. 3D shows a resultant CAD model 331 after running a time-based multi-physics simulation of compression distortion on the CAD model 321 of user interface 320 that subjected CAD model 301 to modeled physics parameters intended to simulate the forces that a part manufactured based on CAD model 301 would be subjected to during the manufacturing process. Compression distortion could be caused by gravity, material composition, surface tension, attachment of the part to fixed surfaces, movement in an assembly, etc., all of which could be captured by the simulation of compression distortion shown in FIG. 3D.

FIGS. 3E-3H depict exemplary sintering transformation distortion simulation user interfaces. For example, user interface 340 of FIG. 3E includes a top view of CA) model 341 representative of a part. There may be high friction simulated between the part/CAD model 341 and the base 343 on which the part/CAD model 341 is positioned, so the part/CA) model 341 may stick as it shrinks. This may make the part/CAD model 341 deform, rather than slide along the base 343. CAD model 341 may illustrate this deformation. User interface 350 of FIG. 3F depicts a simulation environment in which friction coefficients are lower. As a result, CA) model 351 simulates the lower friction coefficients by illustrating a base 353 that breaks free and slides. The simulation may include the feet of CAD model 351 opening up to be pigeon toed, as depicted in FIG. 3F. The “pigeon toe”/opening transformation 352 may be due to shrinkage and friction. The CAD model 351 may warp from the transformation 352 FIG. 3G includes a user interface 360 depicting a back view of CAD model 351 on base 363. In particular, the back view may show a slump 361 in the opened/pigeon-toed CAD model 351 FIG. 311 shows a user interface 370 of a top view of base 373 in which one side 371 of the CAD model breaks free of base 373 and slides. Such sliding may occur once sintering has occurred for a given duration. For example, a part may increasingly “open” during a sintering process in a furnace, until the opening overcomes the friction coefficient, and a portion of the part breaks away from a base. The simulation of system 100 may model such an opening transformation, as shown by the user interfaces of FIG. 3E-3H. In one embodiment, the sliding in FIG. 3H may be shown for a simulation associated with a given time cycle. The exemplary simulations of FIGS. 3A-3H may be performed one at a time, or in any combination.

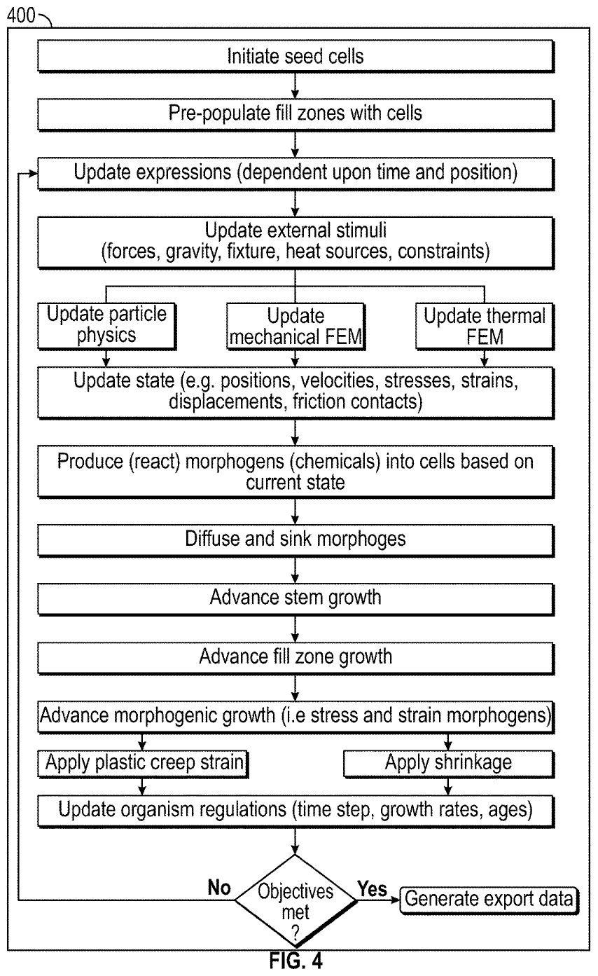

FIG. 4 shows a method 400 performed by system 100 to provide a simulation environment, according to one embodiment of the present invention. For example, system 100 may use a multi-physics engine that models the behavior of solid objects as a combination of rigid bodies, or as deformable bodies. In order to model deformable bodies, system 100 may simulate the material of a part as an idealized “fluid.” One way to achieve such a simulation is by modeling the material as a collection of spheres that collide and resist overlapping. As part of the simulation, system 100 may arrange the spheres in a cube formation, with one cube on each corner of a cell One or more of the steps in FIG. 4 may be optional. For example, the steps involving chemicals and diffusion (e.g., produce mophogens, diffuse and sink morphogens, etc.) may contain a representation of the stress and strain that provides an average effect of stress and strain, and spreads the effect of instantaneous blips in stress and strain. However, in some embodiments, these steps may be bypassed, and the method of FIG. 4 may directly proceed from an “update state” step (e.g., updating stress and strain parameters) to the “apply plastic creep strain” or “apply shrinkage” steps.

A “cell” in the present invention refers to a parameterized, modeling building block that makes up a model of a part in order to simulate the reactions of the part to applied forces over time. For example, a cell may be comprised of a mathematical and visual representation of physical material properties, mechanical properties, electrical properties, thermal properties, chemical properties, or a combination thereof. For instance, one exemplary cell may include a representation of elastic material properties by modeling one or more physical elements, such as springs, dampers, and masses.

For example, the system 100 may attach spring/damper structures along the rectangular grid of spheres and use criss-crossing springs on the faces of each cell-connecting the diagonals across the face of each cell in a model. Such a simulation method may give the deformable structure the ability to change shape without flowing out of control as is the case with a fluid. The structure may then behave as elastic, according to supplied material properties such as Young's Modulus.

The collection of attached spheres with springs and dampers may allow the system 100 to model the interaction of a deformable object as it collides and deforms elastically with other deformable objects in addition to the rigid bodies that are represented by mesh objects.

The multi-physics engine may be coupled with one or more linear elastic finite element method (FEM) modules that may take a mesh representation of the parts as represented as deformable objects, and given the forces and boundary conditions such as friction contact points at some point in the time based simulation, the software of system 100 may provide a stress measure for each point location at the center of the spheres.

Exemplary simulations provided by system 100 may include simulations of plastic creep strain and/or shrinkage. One approach for simulating creep strain deformation may be to modify the normally linear elastic behavior of the multi-physics spring/damper/collidable sphere model with a stress based spring relaxation approach that essentially relaxes the resting lengths of springs over time—from one step to the next. In taking such an approach, system 100 may take the assumption that a spring under load will stretch from its resting length. Over time, the simulated model/structure may reach an equilibrium, where the stretched spring may have a reactive force that equals the applied force. In one embodiment, system 100 may measure the stresses of the material at different snapshot points in time (rather than let the simulated structure reach an equilibrium). In such a case, the measured stresses at snapshot points may be used to modify the spring resting lengths in order to relax them and simulate plastic deformation. This approach may achieve plastic deformation simulation by combining the multi-physics elastic time-based behavior with point-in-time snapshots of stress using a linear FEM simulation.

In one embodiment, system 100 may perform this relaxation to the springs that connect spheres. System 100 may derive the stress at a cell location, along with the strain of the springs, as measured by the deformation versus their resting lengths. Using a scientifically understood relationship of the time rate of strain change—or delta strain delta time as a function of the stress, temperature, and other factors, the system 100 may measure the desired spring lengths along with the resting spring lengths, and change the resting spring lengths as a linear interpolation of the resting lengths and desired lengths—where the interpolation weighting factor may be a function of the strain on that face (edge and diagonal springs on a face) and the stress in the vicinity.

System 100 may also simulate shrinkage by modifying spring resting lengths repeatedly, based on a function of time steps and overall amount of densification that has already occurred. The latter densification may be a measure of the amount the springs have already shrunk. In addition to modifying the spring resting lengths, system 100 may modify the effective collision radii of the particles so that as the material shrinks, it may allow for closer proximity of the particles. In one embodiment, during creep strain, system 100 may maintain the particle radii and relax the springs on the cell diagonals less than the edge springs. This may give the modeled material an ability to deform, while maintaining an element of incompressibility. When the radii of the particles do not change and the diagonal springs remain rigid, the material may deform and bulge outwards—this may be one way for system 100 to simulate the Poisson effect.

Neural Network Driven Tuning Mechanism of the Simulation Environment

System 100 may tune the simulation environment by using a neural network. To ensure accurate distortion compensation, the simulation environment should accurately reflect effects of actual manufacturing processes (e.g., sintering). The following embodiments describe processes to create a simulation environment that accurately reflects outcomes of manufacturing processes. In particular, FIG. 5A is a schematic diagram of an exemplary neural network 500 for building an accurate sintering simulation environment. The inputs to the neural network may include the material constitutive properties of the part and processes, and coefficients defining the simulation processes (e.g., creep strain rates, friction drag coefficients, high temperature elastic properties, etc.). The neural network may output fitness scores. Using the neural network, the system 100 may tune the inputs in order to achieve a set of values that may produce a more accurate simulation of the mechanical processes, which may result in distortions that more closely match actual distortions. The neural network may employ many computers that run the mechanical simulation in parallel.

FIG. 5B shows a method 520 performed by system 100 to tune (e.g., refine) the simulation environment, according one embodiment of the present invention in one embodiment, tuning the simulation of the mechanical distortion may include one or more of the following steps:

1) Receive (e.g., load) a CAD model at system 100.

2) Run a simulation using a sample test part, and a number of input parameters representing mechanical properties, coefficients of mechanical processes such as friction drag, creep rates as a function of strain and temperature. System 100 may produce a simulated distorted part.

3) Receive, at system 100, a 3D digital scan file representing the actual sample test part after the actual mechanical process has been applied.

4) Compute, using system 100, a delta score or fitness score. This score may be the sum of the absolute values of the distances between the original mesh vertices to the distorted mesh vertices. While the exemplary step 4 describes a comparison of meshes, the scores may be derived from a comparison of any form of the simulated distorted part against the accrual test part.

Other approaches of determining the amount of distortion may be used that give weights to certain areas.

5) If the score is bad (e.g., higher than a specified threshold in some scenarios), then the simulation may be run again and again using different parameters. When a final score is obtained that shows accurate simulation (e.g., a score within or under a specified threshold), then the iterative simulation process may be halted.

6) Employ a neural network to detect patterns in the correlation of input parameter changes and resulting score changes.

An example of two input parameters that may be modified by the neural network are the friction drag coefficient and the creep strain rate. Friction drag may characterize how quickly or readily the part slides along the circular supports shown in FIG. 5B The creep rate may be a measure of how fast the part sags in the center. If the drag is too high and the creep rate is too low, the part will sag down on the outside of the circular supports before it has a chance to get pulled up and over the supports into the center due to creep strain. If the drag is too low and the creep strain is too high, the part may get pulled into the center over the supports and not have a chance to sag downwards on the outside of the circular supports. A neural network may change parameters independently and compare the shape of a part based on scores of the deltas between original and final shape in order to determine which combination of inputs gives the best shape. In some embodiments, the neural network may produce its own input training data by running part results made from the neural network's parameter changes, through the neural network and evaluating the scores associated with these results. In some aspects, the outputs of a neural network may be set to a deviation of zero between the original part mesh and the sintered part mesh, and the neural network may be configured to push though data on the original part mesh and the parameter settings of the simulation in reverse to obtain the inputs that might produce the original part mesh after having been subjected to the simulation parameters.

Using the multi-physics based simulation module, many behaviors may be simulated in accelerated real time-including shrinkage as a function of time and temperature, creep strain as a function of stress, strain, temperature, friction drag, material elasticity, Poisson effect, etc.

Alternately or in addition to simulating the complex time-based behavior of the mechanical processes described herein, snapshots, data, or measurement(s) of the shape of a part may be obtained at multiple points during a simulation. For example, a camera in a furnace may collect data on actual deformation of a part by taking images over time Using the time-based progression of a mechanical distortion, functions may be fit to the behavior of the part during the mechanical process. This may be difficult, given the complex 3D geometry involved in many modeling scenarios. However, the shrinkage over time may be computed or predicted, and then this single physical transform aspect could be applied to a design part.

The simulation environment may be used to predict the transformed shapes of parts undergoing one or more mechanical processes.

Iterative Self-Adaptive Part Correcting Mechanism

Once a simulation environment is set up, accurate part correction may take place. In one embodiment, system 100 may provide an iterative self-adaptive part correcting mechanism based on a tuned mechanical process. For example, system 100 may provide an adaptive pre-distortion compensation mechanism in a part design (e.g., a CAD model of a part). For instance, a simulated mechanical process (e.g., a sintering run) may be tuned for a set of material properties and mechanical environmental factors (such as temperature ramp up times). The tuning of such a process may inform geometric corrections or adjustments of a part, e.g., via a self-adaptive part correcting mechanism. An accurate time-based simulation of the mechanical process may be important to obtaining a correct net shape and effectively employing adaptive tuning of negative pre-distortions.

In one embodiment, a self-adaptive part correcting mechanism may use the tuned simulation model based on actual sample parts to generate sets of pre-distorted shapes based on a set of input shapes. These pre-distorted shapes may transform to the desired original shape when run through the tuned simulation and when processed in the actual physical simulation. This mechanism may involve system 100 providing or comprising software that predicts negative distortions that will accurately transform to the original part shape, rather than to an unusable part. The process of the self-adaptive part correcting mechanism may be iterative, employing simulations and corrections, and then applying corrections to the corrections, until the compounded effect of multiple corrections achieves post simulated results that match the original parts. Iterative self-adaptive correction of negative pre-distortions in parts may include system 100 executing one or more of the following steps.

1) Obtain or detect a pre-tuned simulation model for a mechanical distortion and a defined material and environmental factors. This may include the material elastic properties, the time-based shrinkage rate, friction drag, coefficients, time rate of temperature change, etc.

2) Load into system 100 (or receive at system 100), a new design part. Support structure(s) may also be received. The part and/or support structure(s) may be received in the form of one or more CAD models or a 3D scanned data file. The model(s) or file may comprise a triangular mesh, a gcode, or other representation that provides an outer boundary shape that must be negatively pre-distorted.

3) Run a simulation to generate a distorted result.

4) Compare the distorted result to the initial shape. This step may be different from the tuning process step where the simulated distorted result was compared with the actual distorted sample or test part. Here, the comparison involves detecting how distorted the result is from the desired undistorted shape.

5) Determine a negative offset amount based on the distortion. In the exemplary diagram 600 of FIG. 6, since the part sags downwards, each vertex from the initial shape may have a position below in the simulated result. This may be a downward distortion, e.g., distortion 601. The negative distortion may derive a corresponding upwards shift (e.g., shift 603) for each vertex. This upward shift may be the negative of the direction vector of the downward shift, and the magnitude may be the same as the downward shift magnitude or a fraction or multiple. For example, if a point drops 4 mm and a bit to the right, the upward shift may be 3.5 mm upwards and to the left. As shown by FIG. 6, the input parameters may be applied iteratively to prompt a shift (e.g., shift 603) which may compensate for the distortion of a part (e.g., distortion 603).

6) Apply a negative distortion to the original part.

7) Using the first negative distortion, run the simulation again. Again, the simulation result may be compared with the undeformed original CAD part—not the negatively distorted part.

8) Derive a new, second distortion from the above simulation. In the example of FIG. 6, the first negative distortion may be too much, and the part may fail to slump into the correct shape-resulting in a slight positive distortion. Thus, a second negative distortion may be derived, which actually pushes the part downwards—effectively undoing some of the first distortion.

9) Run the simulation on this now compounded negatively distorted part. Measure the deviation of the result against the original shape.

10) Derive and apply a third negative distortion.

Negative distortions may be repeatedly derived and applied until the simulated shape change matches the original part. This process may be adaptive and may correct for unexpected behaviors that may emerge from changing the shape of the part (e.g., in the negative direction) and running the simulation again. FIGS. 7A-7C depict exemplary distortion simulation user interfaces. For example, user interface 700 of FIG. 7A shows a CAD model 701 relative to a physical part 703. The CAD model 701 simulates the slump, creep strain, shrinkage, and frictional drag of a part, its raft, and supports. The left end of the part 703 may exhibit an egg-shaped distortion. The negative pre-distortion may be applied to the part 703, support, and/or raft during manufacture in order to obtain an adaptively negative pre-distorted part that may sinter into a true net shape. User interface 710 of FIG. 7B shows another view of CAD model 701 with a simulated slump, creep, and shrinkage, relative to physical part 703. As with user interface 700, a negative pre-distortion may be applied to the part 703, support, and/or raft during manufacture in order to obtain an adaptively negative pre-distorted part that may sinter into a true net shape. User interface 720 of FIG. 7C shows an exemplary rectangular grid-based cell model that may simulate an accelerated real time multi-physics simulation.

Camera/Scanner/Measurement Data Acquisition for Fine Tuning the Tuned Model

Alternately or in addition, at least one camera, 3D digital scanning device, and/or measurement device (e.g., camera, laser scanner, coordinate measuring machine, touch probe, etc.) may be part of system 100. Such a device may observe (e.g., scan, monitor, image, or measure) the mechanical distortion process. The results of a large number of actual processed part results may be fed into a database along CAD models of the parts, one or more pre-distorted models created by system 100, or a combination thereof. In one embodiment, system 100 may use a neural network to discover patterns in deviations of actual results from original CAD models and the negative distortion models. For example, one may find that the negative distortion model is not accurate for thick parts versus thin parts. The patterns discovered with the neural network analysis may be used to re-tune the simulation model. In other words, one or more digital scan(s)/image(s) of a produced/3D printed part may be obtained and fed back into system 100 to tune the tuned simulation environment, part correcting mechanism, pre-distorted shape(s), or any other design features and manufacturing parameters/models provided by system 100.

The described scanning/data collection may take place at each, or some, of the manufacturing station end points. For example, for scanning during a 3D printing process, a camera may be mounted overhead of a part being printed. In this position, the camera may capture a picture every N passes and use edge detection to find the perimeters of the part being printed. A 3D mesh model may be produced, based on the layer height offsets of the printing process. This 3D mesh model may reflect a structure of the part, as seen from the Z axis. Scanners may also be incorporated into debind and sintering runs. Such scanners may capture scans and/or data of the part and the supports.

In one embodiment, system 100 may be implemented as part of a computer-aided design software package or system. The software package or system may include a growth-based or generative design software using a cell-based approach. A “cell” in this context may refer to a parameterized, modeling building block that makes up a model of a part in order to simulate the reactions of the part to applied forces over time. For example, a cell may be comprised of a mathematical and visual representation of physical material properties, mechanical properties, electrical properties, thermal properties, chemical properties, or a combination thereof. For instance, one exemplary cell may include a representation of elastic material properties by modeling one or more physical elements, such as springs, dampers, and masses. The user may set up modeling constraints that may guide these cells to grow from a set of seed cells into a collection of cells. The collection of cells may grow to form a model of a physical structure. Users may benefit from this solution by being able to create naturally self-optimized designs that they could not have envisioned on their own. Example embodiments can provide design tools that blend principles of growth and adaptation with engineering. In particular, example embodiments may provide elements of cell-level growth behaviors, and may include them into a toolset of building blocks for creating structures. The cells may be programmed to generate populations of cells, as reactions to the simulated application of force. For instance, cells may be added (e.g., “grown”) or removed from a part during a simulation of applied forces. This cell-based approach is discussed in detail, for example, in U.S. Patent Application Publication No. 2019/0138673, entitled “Growth-Based Design System”, and U.S. patent application Ser. No. 16/373,349, entitled “Systems and Methods for Growth-Based Design”, both of which are hereby incorporated by reference in their entireties.

In one embodiment, system 100 may import fill zones from a design software. In one instance, system 100 may then populate the imported fill zones with cells. System 100 may represent the fill zones as plastically deformable bodies that may collide with each other and experience body forces, external forces, and rigid constraints. Alternately or in addition, system 100 may import keep out zones from a design software storage or system and render these imported keep out zones as rigid bodies.

System 100 may provide a time-based simulation where a part may begin to deform under one or more loads-initially elastically. In one embodiment, at every N frames, system 100 may pause simulation and perform stress analysis on deformable meshes of the simulated part, in their deformed states. For each stress analysis, system 100 may use the current set of friction contacts that are detected between the deformable parts and the rigid bodies around them.

The stress results may be incorporated back into the cells, where the system 100 may use the combination of stress, face strain, point in time in the simulation, and a number of input parameters to determine the incremental change in spring resting lengths due to creep strain and shrinkage.

In one embodiment, one or more application(s) of system 100 may be run with no user interface(s), and the design parts may be loaded as files with input parameters, in order to run the automated neural network simulations. The actual result scan/imaging files may also be loaded from a database so that the system 100 may compare the actual point data deviations from the simulated deviations.

Once the system 100 has derived a set of negative pre-distortion values, it may output the negatively pre-distorted shapes for production via 3D printing or other processes. This system 100 may be used to simulate any type of manufacturing process that involves material that changes shape due to heat, chemical transform, and mechanical interaction with other objects. This includes debind processes in addition to sintering.

In summary, system 100 may use a combination of multi-physics based simulation engines to predict the time dependent mechanical distortions. System 100 may tune the input parameters that define these distortion behaviors using a neural network, in order to achieve simulation accuracy on a set of test sample parts, and then apply the simulation to a set of design parts in order to obtain a set of negatively pre-distorted design parts that achieve accurate net shapes when subject to the actual mechanical distortions. System 100 may allow a user to load a part into system 100, and then system 100 may simulate the distortion over time of the part and/or its supports. System 100 may further apply a negative pre-distortion (e.g., correction) to all the part(s) and support(s), to compensate for the distortion. System 100 may include and/or execute one or more of the following elements.

1) a software-based sintering simulation of the time and temperature dependent effects of creep deformation, shrinkage, frictional drag, and cracking during numerous mechanical processes,

2) a means of reading test or sample scanned actual transformed parts (i.e. sintered parts)—this may be a camera or a digital point scanner,

3) a scoring function that ranks the accuracy of the simulation model to actual results,

4) a neural network that varies the input coefficients to the simulation model in order to enable simulated results to best match actual results,

5) an iterative processing engine that uses the neural network to tune the behavior of the simulated transform to achieve a small delta in the simulated to actual results.

6) a processor that accepts a new set of “design” parts to be manufactured, for which a pre-distorted negative transform is desired that will result in transformed parts that accurately match the original parts.

7) a negative pre-distortion mechanism to apply a calculated opposite distortion to the design parts and optional supports based on the delta between a simulated transform of the design part and the original design part,

8) an iteration mechanism to repeatedly simulate the mechanical distortion of the design parts, calculate the delta with respect to the original part shape, apply a negative distortion, run the simulation again, and apply a compounding negative pre-distortion until the result matches the original design part, and/or

9) an export mechanism that produces a negative pre-distorted design part shape.

To further enhance the results of system 100, system 100 may include a feedback loop involving actual processed or generated physical parts. For example, image-based data of physical parts may be obtained via a camera or scanning device, and the image-based data may further inform adjustments or calibrations to be made for accurate manufacturing of a part. A neural network may be used to analyze image-based data for the feedback loop.

Algorithm for Auto Positioning Scanned Compare Zone Meshes

In some aspects, a sintered part may be scanned or imaged to reveal discrepancies between an original design model mesh of a mechanical part, and a resultant sintered part. When a sintered part is scanned (we will use ‘scanned’ herein to refer to imaging, measuring, or scanning of any suitable modality for ease), the scan may comprise or be generated as a scanned mesh, with a coordinate system of reference. The coordinate system of reference may not readily integrate with the coordinate system used in an original CAD model mesh of the part. As such, when the scanned mesh is imported into a workstation with the model part mesh, the scanned mesh may not automatically display as an overlay of or even near the part mesh. In some cases, the display may respond to the different coordinate systems of the model mesh and the scanned mesh by showing the scanned mesh as being off of the screen displaying the design workstation, e.g., if the coordinate systems do not align with one another.

The present embodiment may automatically position a scan of a real part, e.g., a real printed, debound, or sintered part, against point cloud data of the original design model, so that deviation, if any, between the simulated model of the sintered part and the actual (scanned) resulting part may be accurately determined. For example, system 100 may provide an automated mechanism that finds the best position, or a range of optimum positions, to eliminate a translation and/or rotation deviation between a compare zone mesh (e.g., a scanned mesh of a real part) and the final working mesh representing the distorted sintered part. System 100 may additionally or alternatively provide manual translation and/or rotation tools that allow a user to manually orient one or more scanned compare zone meshes and place them close to the original CAD part mesh. In some embodiments, once the user manipulates the scanned compare zone mesh and/or the CAD part mesh, system 100 may include an automated mechanism to perform a closer alignment of the two meshes for comparison. In other words, system 100 may automatically position the scanned compare zone mesh and/or the CAD part mesh relative to each other for comparison, may allow a user to manipulate the scanned compare zone mesh and/or the CAD part mesh to position them relative to one another, or may allow for both some manual manipulation and some automation of the alignment process.

The automated mechanism may comprise an algorithm performing exemplary method 800, shown at FIG. 8. Method 800 may include implementing a search algorithm that would nest three for loops, each one iterating over angles. e.g., rotational angles, about the X, Y, and/or Z axes Before beginning the iterations, the scanned compare zone mesh may be translated (automatically or by a user) so that its bounding box center coincides with the final working zone mesh (step 801) This may remove any translation effects. Then, for each iteration step of angle about each of the axes (step 803), the rotation deviation caused by the difference between the scanned compare zone mesh and the final working positions mesh may be calculated (step 805). Steps 803 and 805 may be repeated for each angle, or a subset of angles about each of the axes. Step 807 may include determining, based on the calculated rotation deviations calculated for each iteration, the orientation about X, Y, and Z that gave the lowest overall deviation.

Alternately or in addition, the automated mechanism may comprise an algorithm performing exemplary method 900, shown at FIG. 9. Method 900 may include performing a binary search within the space of a set of rotational axes. An exemplary set of rotational axes may comprise three rotation axes, the X, Y, and Z axes. The binary approach may include breaking each of the axes associated with nested for loops (e.g., of method 800) into two 180 degree increments (step 901).

Step 903 may include running through the 3 for loops. Since each of the axes may be broken into two increments, step 903 may include 6 iterations—each iteration corresponding to a quadrant of the positive/negative quadrants about the X, Y, and Z axes. Step 905 may include identifying, of the 6 quadrants, the quadrant producing the lowest rotational deviation. For example, steps 903 and 905 may include computing a rotational deviation for each of the 6 quadrants defined by the 6 axis increments. The lowest of the computed rotational deviations may be identified, and the axes or quadrant associated with the lowest computed rotational deviation may be determined. This determined quadrant may be the quadrant producing the lowest rotational deviation.

Next, this determined quadrant may be broken into two 90 degree increments about each of the 3 axes, again performing 6 iterations (step 907). This may allow determination of the orientation, of the six incremental orientations within the space of this quadrant, which produces the lowest rotational deviation. This refinement of the range values for each of the three X, Y, and Z axes may be repeated until the increment is small enough to allow the scanned compare zone mesh to have a sufficiently small rotational deviation with respect to the final working mesh positions (steps 909 and 911). For example, step 909 may include comparing the computed rotational deviation to a predetermined rotational deviation value. The predetermined rotational deviation value may represent a threshold value of deviation below which would mean acceptable value of deviation permitted between the scanned mesh and the working mesh. This predetermined rotational deviation value may be input by a user, or pre-defined by system 100. The predetermined rotational deviation value may vary, depending on the level of refinement desired for matching the scanned mesh to the working mesh. Step 909 may include determining whether a computed rotational deviation is less than (or, in some embodiments, less than or equal to) the predetermined rotational deviation value. If the computed rotational deviation is less than (or equal to) the predetermined value, then the method may proceed to step 911. If the computed rotational deviation is not less than (or equal to) the predetermined rotational deviation value, then steps 905, 907, and 909 may again be repeated. Steps 905, 907, and 909 may be repeated as many times as necessary to fall within an acceptable threshold of values. Step 911 may further include aligning a scanned part mesh to an original part mesh based on the identified one or more axes or quadrant. The method may output the quadrant at which the computed rotational deviation was less than the predetermined threshold rotational deviation value.

Another embodiment of method 900 may include dividing the mesh surface into grid regions. For example, a sphere surface could be broken into 8 quadrants. A part may have dozens or hundred(s) of such quadrants and surfaces A deviation score may be calculated for each region. A neural net or other artificial intelligence/machine learning technique may be used to analyze the output and to identify regions that have a good score, as well as regions that may have bad score in terms of how closely the resultant (scanned) physical part deviates from the original design model mesh. This technique of computing a deviation score may also be used for tuning the simulation environment and ensuring that a simulated model accurately reflects the machining process, e.g., a sintering simulation accurately reflects the effects of sintering on an object.

Algorithm for Iteratively Generating Negative Distortion Vectors

System 100 may also provide a negative distortion algorithm, which may generate negative distortion vectors. The algorithm may iteratively adjust a negative offset and re-run a generative design simulation until the simulation result matches a desired part shape. The algorithm may execute the following exemplary method 1000, shown at FIG. 10. Step 1001 may include initializing a map of negative distortion vectors, where there may be one vector for each of the particles (vertices) in an initial cell mesh. The initial value of each negative distortion vector may be the position of each of these initial cell position vertices within the initial cell mesh.

Before a generative design simulation runs, the initial cell positions may be applied to a working mesh that will undergo the simulation and leave the initial cell positions intact (step 1003). This working mesh will may deform due to simulated sintering and the working mesh may be updated after each sintering run with new positions.

A first sintering simulation may be run on the initial working part mesh (step 1005). When the sintering simulation runs, the working mesh may shrink and slump. At the end of the round of simulation, the difference between the final position of each cell, or a subset of cells, in this working mesh and the initial cell mesh positions may be calculated (step 1007). The negative of each of these vectors may be added to the negative distortion vectors in the map, given the difference between each final position and initial cell mesh position (step 1009). This may be the first update of the negative distortion vectors.

Once each of the negative distortion vectors have been updated, the updated values may be applied to the positions of the working mesh to generate an updated working mesh (step 1011). The sintered and distorted working mesh may then represent the negative offset positions. This sintered and distorted working mesh may comprise an updated working mesh. For example, the updated working mesh may be bigger and bulgier than the original cell positions, because it has been negatively distorted. The updated working mesh may be repositioned in a simulation design space, to account for the dimensions and projected changes to the updated working mesh. For example, the updated working mesh may be translated in a direction opposite a gravity force so that the mesh is above a “floor” surface in a simulation, such that when the gravity force is applied in a simulation, the new working mesh would not intersect with the floor (step 1013). The negative distortion to the initial cell mesh may push the mesh into neighboring geometry, e.g., preset surfaces or mesh/geometry of other parts.

The simulation may be run again (step 1015) on the updated working mesh. When the simulation is finished, the final/post-simulation updated working mesh positions may be compared to corresponding cell positions of the initial post-simulation working mesh (step 1017). The computed difference between the post-simulation position of each cell in the final working mesh and its corresponding cell positions of the initial post-simulation working mesh (e.g., from step 1017) should be less than the computed difference between the post-simulation position of each particle in the initial post-simulation working mesh and its corresponding initial cell position (e.g., from step 1007). In some places, the difference between the final working mesh position and the initial offset position working mesh may not have distorted enough in response to the negative offsets, while in other places it may have still distorted and shrunk too much. The goal is to generate a final working mesh that looks like the initial cell mesh.

The difference between the final working mesh and the initial cell mesh positions may be calculated (step 1021) and the difference in the negative distortion vectors may be added to the negative distortion vectors map (step 1023). In one example, the first simulation run may have distorted a point on the working mesh downwards by 5 mm below the initial cell position. The negative offset may cast the point upwards by 5 mm. On the second simulation run, the final working mesh position of this point might be 1 mm below the initial cell position. This means that the initial negative offset may not have been enough, and as such the new negative offset would be 6 mm above the original position. On the other hand, if the final working mesh position was 1 mm above the initial cell position, it would mean that the initial negative offset may have been too far. As such, the updated negative distortion vector may be 4 mm above the original position.

Once the negative distortion vectors have been updated, the negative positions may be applied to the working mesh. The working mesh may be adjusted (e.g., translated so that it lies above the floor and does not intersect with it), and the simulation is run again.

Each time the simulation runs, the negative distortion vectors may be updated. This process may be repeated until the final working mesh positions fall within an acceptable tolerance of the initial cell positions. At this point, the negative distortion vector map may be deemed complete.

System 100 may maintain and save the initial cell positions, negative distortion vectors, and working mesh such that if the user saves the model and opens it again, the simulation may be continued where it left off.

Algorithm for Creating Negative Distortion Mesh from Negatively Distorted Cell Mesh Positions

In this embodiment, the original geometry may be morphed or converted to negatively distorted geometry, using the distortion data that is derived from cells. In short, detailed part geometry may be received, mapped to a set of discrete cells, a simulation may be run and the cells distorted. The distorted cells may then be used to derive negative offset vectors that may be applied to the original geometry. This embodiment may comprise an export algorithm that consolidates and stores the negative offset vectors determined from the distorted cells. This embodiment is described in more detail below, and as exemplary method 1100 of FIG. 11.

Step 1101 may include importing a detailed part model, e.g., model 1200 of FIG. 12. The imported part model may be in the form of a CAD model comprising a mesh that contains a combination of large triangles in regions that are planar, and small triangles in areas where there are tine details such as threads and small fillets Method 1100 may comprise creating a cell mesh from this imported part model. The cell mesh may serve as an object that may undergo simulations to experience deformation, shrinkage, and ultimately negative offsetting.

A particular challenge is, applying the distortion that exists within resulting cell mesh to the original CAD part mesh, which may have more detail in fine feature areas (e.g., fillets, holes, threads) while having less detail in large planar areas. Step 1103 may include re-meshing the imported part model such that it has enough degrees of freedom to capture the transformation of flat, or nearly flat areas into slightly curved ones, e.g., model 1203 of FIG. 12.

A new triangle mesh may be defined corresponding to the initial cell positions of the model (step 1105). An exemplary block or triangle mesh (or a mesh consisting of any suitable shape of individual cells) is shown as model 1205 of FIG. 12. This mesh may be blocky with stair steps because it represents the mesh of cells. An exemplary mesh model 1205 may have a resolution of 0.5-0.75 mm. Some of the cells may push through the envelope of the original CAD mesh, while others may lie just inside the original mesh due to the fact that this mesh is a discretized working mesh that will undergo the physical simulation of sintering and negative offsetting operations.

A sintering simulation may be run one or more times on the cell mesh (step 1107). After each simulation run or subsets of simulation runs, a negative offset vector field may be updated (step 1109) Each vector may represent the displacement of one of the cell vertices from the original cell mesh in, e.g., model 1205, to the final shape of the negatively distorted mesh. An exemplary resultant vector field 1207 may be seen FIG. 12. For each cell vertex in the original cell mesh there may be a corresponding negative offset vector.

At step 1111, a continuous displacement vector function may be defined on the triangle mesh (e.g., model 1205), which may have vertices that coincide with the initial particle positions. The function value at mesh vertices may be defined as the difference between positions before and after simulation. The function value on triangle interior points may be defined as the barycentric sum of function values at triangle vertices, as shown in model 1209 of FIG. 12. In other words, if one wanted to find the displacement of a vertex on remeshed part 1203 that was pan way between two vertices on the initial cell position mesh 1205, the first step would be to project this vertex to the nearest vertex on the initial cell positions mesh, and then find the negative offset vectors of the neighboring vertices. The resulting transformation may comprise a weighted sum of the negative offset vectors of the neighboring vertices.

As step 1113, the vertices of the remeshed part (e.g., of step 1103) may be projected onto the initial cell positions triangle mesh (e.g., of step 1105). For example, each vertex on the remeshed part may be projected onto the initial cell positions mesh, to find the neighborhood of nearest vertices on the initial cell positions mesh. This set of nearest neighbors may be used to look up the negative distortion vector for each vertex (or one or more vertices). In particular, the barycentric sum of these vectors may be used. This usage of the vectors may take into account the distance of each neighboring vertex, in order to establish the correct weighting for each vector. For example, a nearby neighbor that is very close may have a higher weight applied to its negative offset vector than a nearby neighbor that is farther away. Once the combined or weighted negative offset is determined, this negative offset vector may be applied to the remeshed part position for each vertex. The effect of this operation is that each vertex (or one or more vertices) on the remeshed part may be negatively offset by the proper weighted amount corresponding to the nearby negative offset vertices. This projection may push the high fidelity triangles from the remeshed part onto the coarser initial cell positions mesh

The projected points from step 1113 may be translated (as step 1115) by a displacement vector that is evaluated at the projected point, using the function defined in step 1111. The result may be a high fidelity mesh that is distorted to reflect the negative offset of the deformed cell mesh. Step 1117 may include outputting this high fidelity mesh.

The systems, devices, and methods disclosed herein may also be used to inform the generation of manufacturing support structures for parts. For example, parts made with distortion corrections may require additional supports, fewer supports, or no supports. System 100 may provide automatic determinations regarding suggested support structures for making parts containing distortion corrections. In some aspects, system 100 may generate distortion corrections that may reduce or replace the need for supports (or smaller supports). For example, instead of requiring the presence of a support to uphold an overhanging bridge portion of a part, a distortion correction may be applied that forms the bridge portion in an arch shape so that the final bridge portion has a straight, horizontal profile, even without the presence of a support underneath. It is also possible that the need for supports may be reduced, e.g., fewer supports are needed, or those that are needed are less critical or smaller in scale.

System 100 may further provide automatic recommendations for manufacturing, in light of the distortion corrections. For instance, system 100 may provide recommendations as to printing orientation, sintering temperature or timing, part material distribution, etc., based on the distortion corrections. The many capabilities of system 100 may be used in any combination to enhance reliability in producing physical parts that match an intended geometric structure of the part.

Disclosed now is a method of using a scan(s) of a transformed post-process part(s) (e.g. a scan(s) of a sintered part(s)) to modify a pre-process shape part, so that the modified pre-process shape part may produce a more accurate result in a subsequent transformation operation. This modification of pre-process shape parts is referred to herein as “scan adjustment.” In certain embodiments, the method includes reading a collection of scans of different post-process shape parts to produce a “composite” or “average” scan to be used in scan adjustment. In certain embodiments, noise may be removed from scan data by producing an averaged composite scan. In certain embodiments, a computed tomography scan (CAT) scanning device can be used to obtain scans that observe internal features not accessible via line-of-sight optical light scans. These scans maybe used in scan adjustment to compensate for the internal regions of pre-process shapes. In certain embodiments, noise may be removed from scans via smoothing operations in order to reduce the introduction of surface noise into the pre-process shapes during scan adjustment. In certain embodiments, an incomplete scan of a post-process shape part can be utilized to define a volumetric deformation map that may be applied to the entire pre-process shape part, even in areas where scan data may be missing.

In certain embodiments, select surfaces of a design part can be identified that should not be deformed during either the generation of a pre-process shape part or the modification of the pre-process shape during scan adjustment. These surfaces may form planar or analytical surfaces on the design part. After the generation of the pre-process shape part, or modification of the pre-process shape part during scan adjustment, these surfaces may be further modified to comply with planarity or analytical surface properties observed in the design part with some scaling applied.

Scans of powder produced parts that are sintered or otherwise transformed via shrinkage and distortion may be used to help modify pre-process shape parts in order to produce better results (i.e. post process shape parts). The goal in creating a pre-process shape part is to minimize distortion in the post-process shape part that may cause a deviation in the post-process shape from the desired shape. If the pre-process shape does a poor job in reducing deviations in the post-process shape, then the pre-process shape must be “tweaked” or modified in order to produce a better result. When a pre-process shape part is transformed via a process such as sintering, the part may shrink and distort due to uneven shrink rates caused by density variations within the part. These density variations may be the result of the powder forming process. Powder processed parts may be created via 3D printing or injection molding of a powder mixture combined with a binder or flowing agent. When the binder agent dries or solidifies, the powder part may become rigid. These rigid parts (known as pre-process shape parts) may then be transformed using a process involving extreme heat (ex. sintering), to densify the part into a finished post-process shape.

There are definitions that are useful in understanding the context of the following disclosure and claims:

Object: the part resulting from the manufacturing process.

Part mesh: data structure comprising triangles representing the surface of the final desired shape.

Part mesh vertices: points in a part mesh corresponding to triangle corners.

Aligning: Translating and rotating a dataset as a whole.

Adjusting: moving/transforming portions of the mesh.

Pre-processed part mesh: pre-sintered (transformed e.g. scaled up, scaled down, distorted, etc).

Manufacturing process: a process which creates or modifies the shape of a pre-processed part mesh (e.g. sintering, curing, DLP printing, etc.).

Scan data: a collection of points measured from the surface of a post-process shape part by scanning. Optionally assembled into a triangular mesh where points are connected to their nearest neighbors.

Scan adjusted delta vectors: Delta vectors represent displacements of vertices from a part mesh to a pre-process part mesh. Scan adjusted delta vectors are modified delta vectors that compensate for deviations between a scan of a post-process shape part and a part mesh.

Barycentric weighting factor: A coefficient assigned to a vertex of a simplex (e.g. triangle, tetrahedron), or regular solid (e.g. cube) used in conjunction with the other coefficients of the shape's vertices, serving to define a blending of vertex coordinates to represent a composite set of coordinates.

A design shape represents the desired tolerances and dimensions required for the part after processing operations. To derive a post-process shape that matches a design shape, one must first create the pre-process shape geometry from the design shape. This geometry may be in the form of a 3D mesh file in a format such as STL. This pre-process shape geometry may then be used to manufacture a tangible part instance via a powder forming process. This process could be 3D printing or injection molding. Next, the pre-process shape part may be subjected to a transformation process (e.g. sintering), which may shrink and deform the part. The result may be called a post-process shape part. Ideally a post process part will have the same dimensions as the design part.

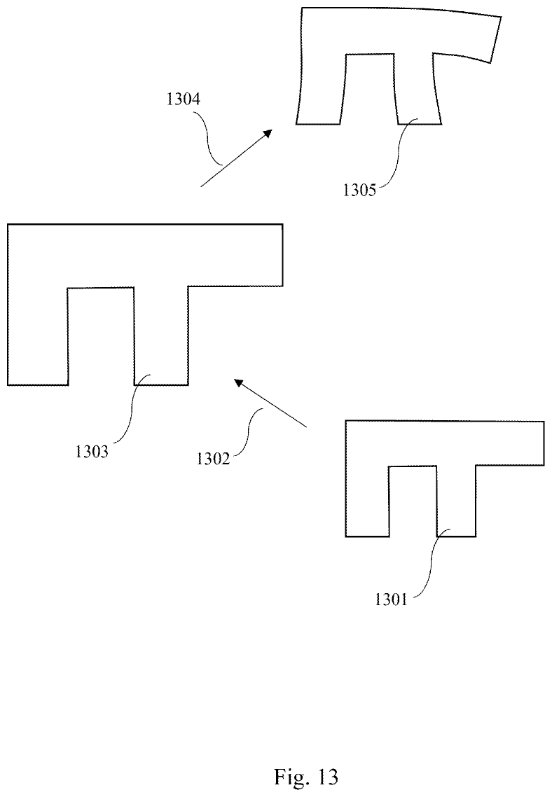

With reference now to FIG. 13, in an existing method an initial design shape 1301 may be linearly scaled up in step 1302 to produce a pre-process shape 1303, which is then transformed (e.g. sintered) in step 1304 to produce a post-process shape 1305. As illustrated in FIG. 13, simple linear scaling to produce a pre-process shape may produce mediocre results with significant warpage.

There are more sophisticated methods for approaching the problems of shrinkage than linear scaling. For example, the pre-process shape geometry may be scaled up by different scale factors in different directions. The pre-process shape geometry may be further deformed so that the pre-process part may shrink and deform while undergoing the transformation process, and ultimately attempt to reach the shape of the design part.

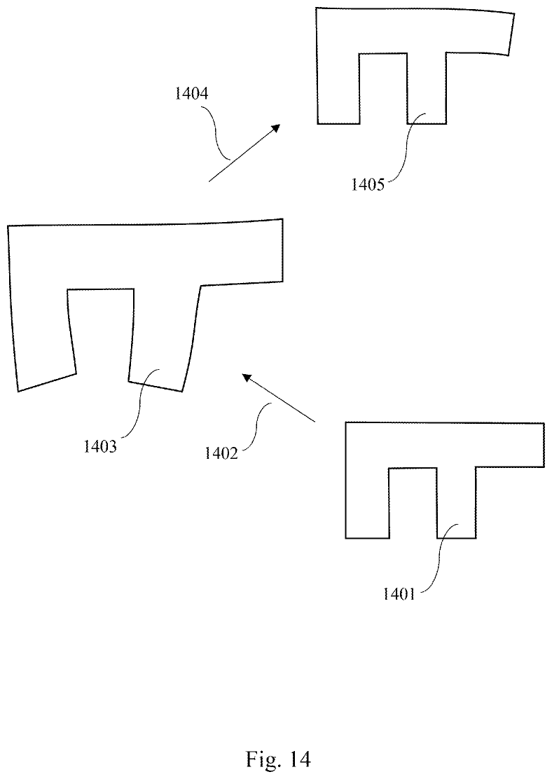

FIG. 14 illustrates another method of attempting to compensate for shrinkage and distortion. Particularly, after running a sintering simulation the deformed cell mesh is compared to the desired shape and a negative offset shape is developed in pre-process step 1402 to produce a negative-offset pre-process shape 1403 that is then transformed (sintered) during step 1404 into final post process part 1405. A negative offset shape may produce more accurate results as both shrinkage and distortion from the transformation process are factored into the generation of the negative offset shape. Note that in FIG. 14 the negative-offset pre-process shape is bent upwards on the right side so as to produce a post-process shape that is nearly straight. In FIG. 13 the pre-process shape produced via linear scale up results in a more bent post-process shape part due to the fact that it does not compensate for the sagging or downward bend during the processing transformation (i.e. sintering). In both the linearly scaled up pre-process shape case and the negative-offset pre-process shape, there may be some distortion in the post-process shape that remains. The disclosed scan adjustment operation improves upon these methods to improve the final post-process shape.

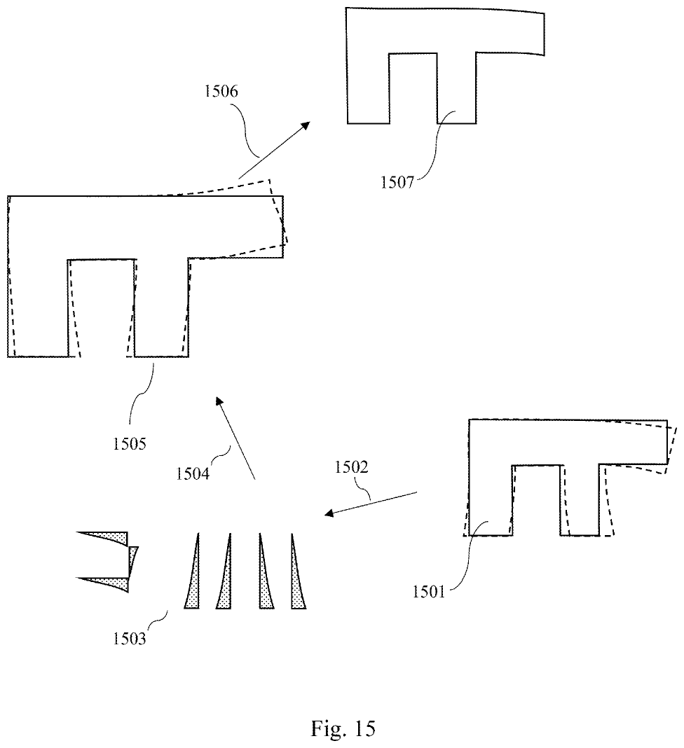

FIG. 15 depicts a scan adjustment of a linearly scaled part. This will generally be a crude method to create a pre-process shape that may not scan adjust well. First, a part is linearly scaled, printed and processed. A scan is then conducted of the post-process shape. A deviation analysis is performed during step 1502 to compare the post-process shape with the design shape to produce a map of vectors that describe the motion of each vertex on the post-process shape to the design shape 1501. The deviation mapping 1503 describes the error between the post-process shape part and the desired design shape. The negative of the deviation mapping is used during step 1504 to produce a new pre-process shape 1505, which then undergoes processing during step 1506 to produce a final post-process shape 1507. FIG. 15 illustrates the case where a deviation map describes that the post-process shape has slumped below the design shape in a region (e.g. the right side overhang). In this case, the pre-process shape needs to be modified in this region so that the new pre-process shape is pushed upwards relative to the original pre-process shape. This modification of moving the region upwards will subsequently cause the next transformed post-process part to better match the design shape. FIG. 15 furthermore illustrates the scan adjustment being applied to a linearly scaled up pre-process shape. Typically, a linearly scaled up pre-process shape will be a crude representation of the shape that needs to be generated in order to produce a post-process shape that has little or no deviation with the design part. This is because linear scale up does not account for distortion caused during the transformation process due to friction and gravity.

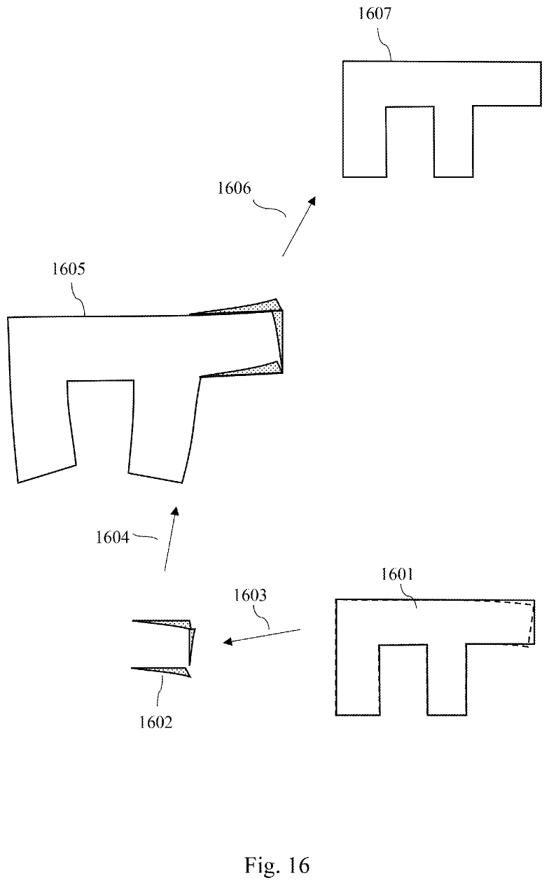

With reference to FIG. 16, a negative offset pre-process shape is processed and the resulting post process shape is scanned and compared to the design shape 1601. When the modified pre-process shape is transformed, the deviation of the post-process shape from the design shape will be less than when a linearly scaled up pre-process shape is transformed. Distortion map vectors 1602 corresponding points on the pre-process shape are developed in a process 1603. For each distortion map vector describing the deviation of a vertex on the post-process shape to a corresponding vertex on the design shape, a scale-up operation may be applied to the vector, and the vector may be added to a vertex in the mesh of the pre-process shape in step 1604. For example, if a region of the post-processed shape is 1 mm lower than the design shape, then the distortion map vector from the scan of the post-process shape to the design shape will be a 1 mm long vector in the upward direction. If the shrink rate in that region of the part is 0.9, meaning that the part shrinks 10%, then the 1 mm long upward vector may be multiplied by 1/0.9 or 1.111. The vertices of the pre-process shape in that region may then be offset by vectors pointing up with a magnitude of 1.111 mm. When the pre-process shape is then transformed again in a subsequent iteration of the transform process (i.e. sintering), these regions may shrink by 90% and deform, and the final point locations may be 1 mm higher than they would have been without the compensation. The deviation of final post-process point locations from the corresponding design shape locations may thus be a vector of length 0. Finally the altered pre-process shape 1605 undergoes processing in step 1606 to produce a final post-processed shape 1607 which now closely matches the design shape 1601.

Averaging a Collection of Scans

Disclosed also is a method of using a collection of scans obtained from scanning multiple instances of post-process shapes to produce a composite or average scan to be used in scan adjustment. Different instances of post-process shapes may contain noise or anomalies due to the transformation process. The method may include performing an averaging of all the scans to eliminate noise and produce a master scan.

To produce an average of scans, a collection of scans may first be automatically positioned with respect to each other in order to minimize registration errors prior to calculating the average. In one embodiment, a set of 3D printed parts from different regions of a bed maybe sampled and scanned in order to produce a composite scan that cancels out the effects of scaling variations due to powder bed packing gradients. In some cases, one side of a bed may produce higher density parts than the other. By sampling and scanning multiple instances of the same part shape from different regions of the bed, and then using the scans to generate an averaged master scan, the noise of powder bed density variation may be eliminated.

The method of aligning meshes with respect to a design mesh may involve a first rough alignment of each mesh relative to a design mesh. The rough alignment of a design mesh and a scan mesh may include computing the principal axes and rotating the scan mesh solid so that the axes align. The rough alignment may then be followed by a precise alignment using the iterative closest point algorithm.

Once a set of scans has been aligned relative to a design part, the method of generating a composite scan may include taking a first scan mesh and iterating over vertices of that scan mesh, and projecting each vertex from the first mesh onto other the other scan meshes, then taking the average of each first mesh vertex and corresponding projected vertices and setting the vertex coordinates of the first mesh to the averaged coordinates. Next, the method may include moving to the second and subsequent scan meshes and performing the same operation. Next, this process may be iterated M times. Finally, one of the meshes may be used in the scan adjustment operation.

CAT Scan to Obtain Internal Features

Disclosed also is a method of using a CAT scanning device to obtain a scan of a post process shape that may include some of the internal cavities of the shape. A CAT scan may observe regions inside the part that are not accessible via line of sight measurement approaches, such as structured light or laser based scanning system. CAT scans may employ X-rays to penetrate through optically opaque sections, allowing scans to include data from internal geometries.

Noise Reduction of Scans

Disclosed also is a method of applying noise reduction on scans in order to remove small surface variations that may not be desired in the deviation map. One goal of a scan adjustment is to modify pre-process shapes without introducing scan noise into the pre-process shape. Scan adjustment should bend the pre-process shape, without introducing small surface perturbations that may have been picked up by a high resolution scan. An embodiment scan may typically have 100 MB of data whereas a desired scan resolution for atypical part may be 10 MB.

In one embodiment the mesh vertices of a scan may be removed to produce larger triangles, where the larger triangles may not deviate from the original triangles by more than a threshold distance such as 0.1 mm. In another embodiment, Laplacian smoothing may be applied to scan vertices to reduce noise.

Volume Based Adjustment to Handle Missing Scan Data

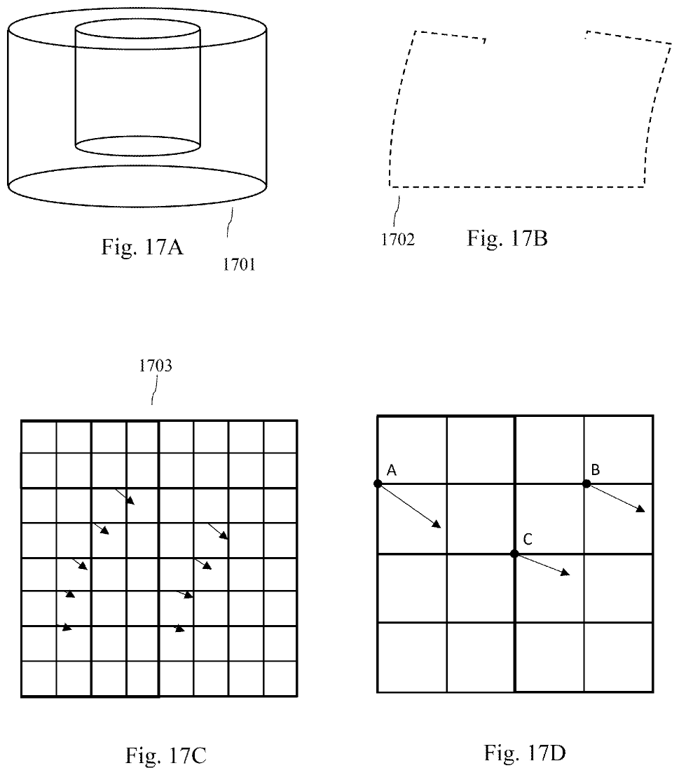

Disclosed also is a method of applying a volumetric scan adjustment in cases where scans may contain dropouts in data. For example, and with reference to FIG. 17A, a design part in the form of a tube closed at one end may be used to produce a pre-process shape that results in a post-process shape after a sintering transformation. If a scan of the post-process shape part 1702 (shown in FIG. 17B as a side plan view) indicates that the post-process shape has shifted in a region via a bend to the tube, resulting in a translation, then the scan adjustment operation will shift the pre-process shape in the opposite direction for this region. However, if scan data is missing for the internal hidden portion of the tube as shown in FIG. 17B, then the inside of the pre-process shape may not be moved in concert with the outside. This may result in a modified pre-process shape that now has uneven wall thicknesses—meaning that one side of the tube may be thicker than the other side.

With reference now to FIG. 17C, the method of scan adjustment for cases where there are dropout regions is to generate a deviation map 1703 of vectors for the regions that do have scan data. Next, a 3D grid may be defined over a volume and deviation vectors for each location within the grid may be assigned. Next, when a scan adjustment vector is derived for a region, the nearest volumetric locations with scan data may be looked up and the deviation vectors obtained. If these locations are nearest neighbors in the volumetric grid then a simple interpolation of the neighbors may be used to define a combined scan adjustment. However, if nearest neighbors are missing deviation vector data due to dropouts in the scan data, then an algorithm may be used to walk along the directions of the 3D volumetric grid from neighbors that do have values for deviation vectors back towards locations that do not, computing a composite deviation vector for that empty location using a weighting of available neighbor deviation vectors. Using this approach, a scan adjustment vector may be derived for a location in the 3D volume grid for which there was not a deviation vector corresponding to scan data.

For example, a vertically oriented tubular shaped part may have scan data for the left and right sides of the tube, but may be missing scan data for the inside of the tube. When deriving the deviation map vector for a vertex on the inside of the tube, one may “walk” to the left and right sides of the volumetric grid where scan data may exist for corresponding vertices. These scan deviation values may be used in conjunction with a weighting function that measures the distances of vertices containing scan data to the vertex that is missing scan data. For each vertex with scan data, the deviation vector for that vertex may be multiplied by a weight that is a function of the distance. Farther distances may result in a lower weighting.

With reference to FIG. 17D, scan data may be obtained for regions on the outside of a tube shaped part, labeled regions A and B. For regions A and B, deviation vectors may be derived for each point on the scan that moved from an original location on the part. This deviation vector data may be overlaid upon a volumetric grid. Regions such as C corresponding to the inside of the tube where scan data may be missing may have their deviation vectors derived by taking a weighted average of the neighboring regions A and B where deviation vectors may exist from the scan data. As described further in paragraph [0195], the missing weighting factors may be found as follow: for any node that is missing a deviation vector, an equation is written that defines the value as a linear combination of its neighboring values. For the X nodes that have missing values this will produce a set of X equations of X unknown vectors. By solving the linear system of equations the missing node values may be filled.

When determining the amount of scan adjustment compensation to apply to the part, regions of the volumetric grid where deviation vectors have been derived may be used where scan data is missing. The amount of compensation for a region of the part where scan data may be missing may be the negative of the derived deviation vector C with an additional scaleup factor applied to account for shrinkage.

Preservation of Flatness in Generating Negative Offset Pre-Process Shapes

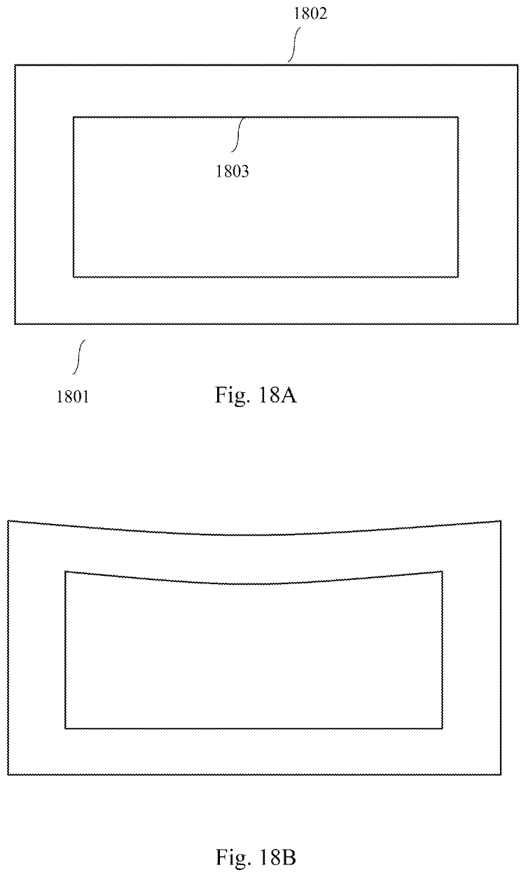

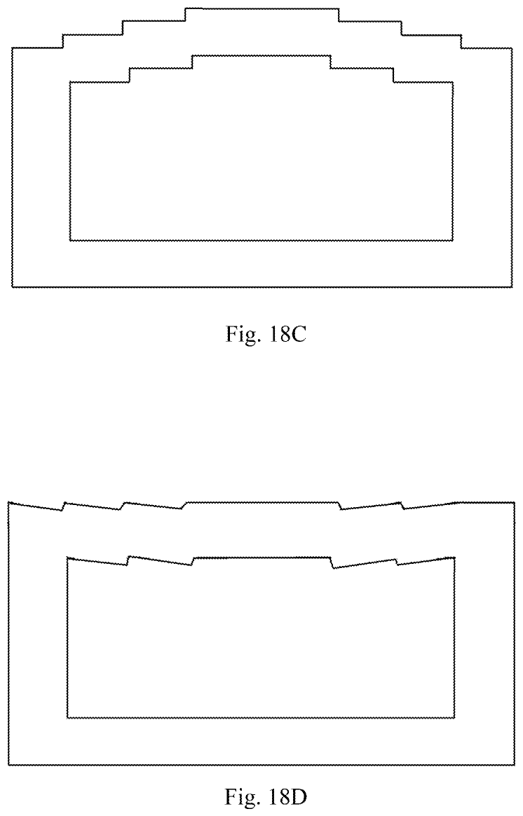

Also disclosed is a method during the generation of a negative offset pre-process shape whereby surfaces may be preserved to comply with analytical shapes such as planes, spheres and cylinders. With reference to FIG. 18A, a design shape 1801 may be a 3D mesh. Negative offset modification may be used to produce a pre-process shape mesh may cause a collection of triangles that originally formed a planar surface on the design shape to deform to a non-planar surface. This may be the case when a planar surface sags under gravity, and whereby the negative offset modification may lift regions that sag. This lifting may result in a domed surface on the pre-process shape. In some cases a user may prefer to have the pre-process shape remain planar in surfaces 1802 and 1803, rather than domed, so that when it is formed with powder using a 3D printing process, there will be no layering or terracing produced in the printed shape. The downside of this maintenance of flatness, as shown in FIG. 18B, is that the post-process shape may sag if it is produced from a flat pre-process shape versus a domed shape. The tradeoff is one of smoothness in the post-process shape along with low dimensional accuracy (i.e. a smooth but sagged part) versus a post process shape with surface roughness caused by printed terrain lines in the dome region along with high dimensional accuracy (i.e. a rough but straight part). In contrast, FIG. 18C depicts a pre-process shape wherein surfaces 1802 and 1803 are compensated for deformation. FIG. 18D depicts the pre-process shape of FIG. 18C after post-processing. Surfaces 1802 and 1803 are dimensionally accurate but are stair-stepped in nature.

Mesh Registration Mechanism

Now described is a detailed embodiment example of a method of mesh registration. A mesh registration takes as input a set of N meshes. These may be triangle meshes, though meshes of other shapes such as squares may be employed as one of ordinary skill in the art to which the present disclosure pertains will understand. The goal is to move the vertices of each mesh so that the shape of each mesh resembles that of the other meshes.

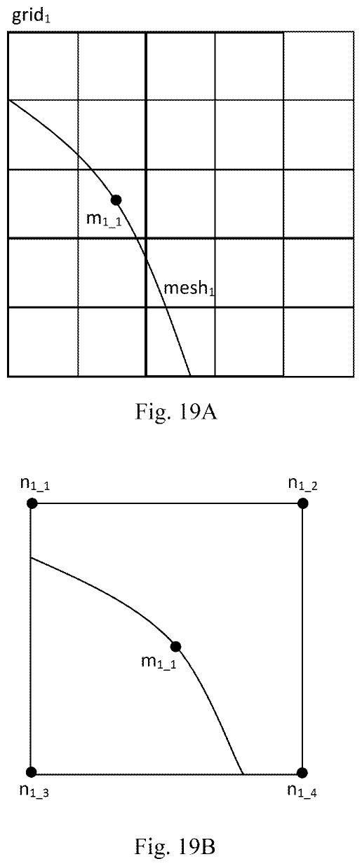

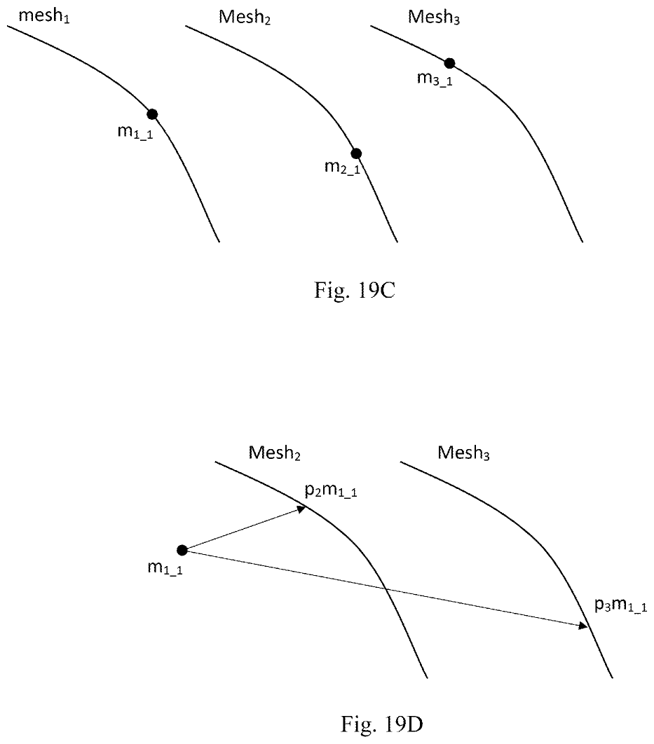

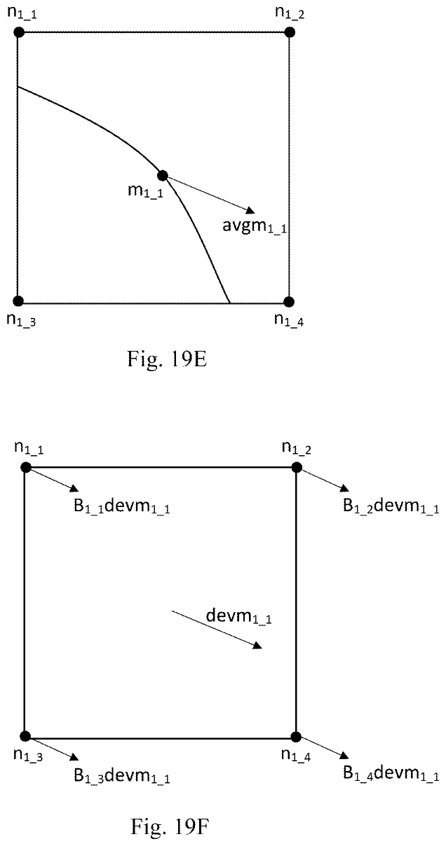

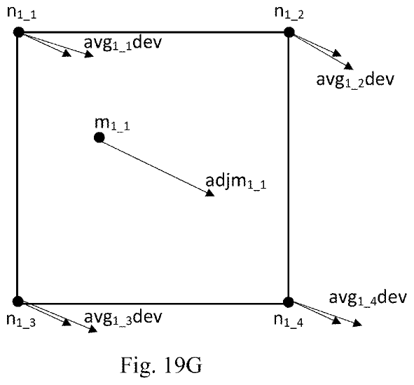

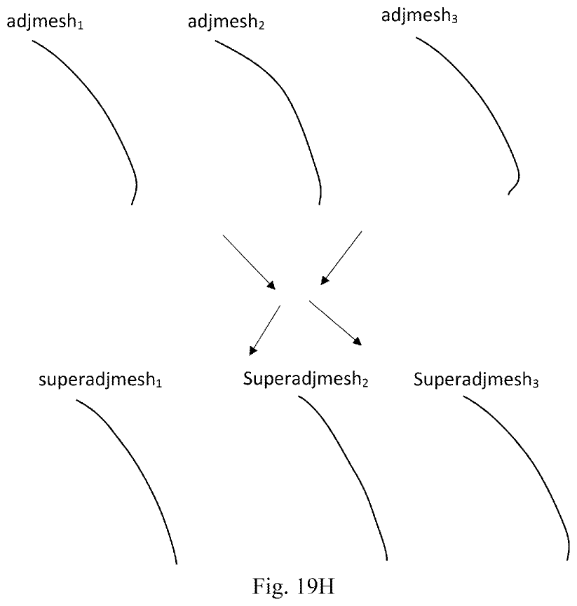

1) A volume grid is superimposed over each of the meshes of a part. In the embodiment, each volume grid is named grid with a subscript for the mesh number—i.e. grid₁ is shown in FIG. 19A.

Each mesh is referred to by a similar naming convention such as mesh1. Each mesh has a unique number of vertices referred to by an m and a subscript of the mesh number and the vertex number i.e. m_{1_1} to m_{1_n}.

2) With reference to FIG. 19B, the grid is cubic and at each cube corner there is a node. The nodes are referred to as N_{1_1} through N_{1 _P} where the first subscript indicates the grid number and the second subscript number indicates the node number.

Mesh vertices fall within the grid cubes. Some grid cubes will contain more or fewer vertices than others.

3) With reference to FIG. 19C, in the example there are three meshes being processed.

4) With reference to FIG. 19D, each mesh is processed sequentially. Starting with the first mesh, the first vertex is projected onto the other meshes. The projected points are referred to as p₂m_{1_1} and p₃m_{1_1}.

5) With reference to FIG. 19E, the next step is to compute the average of these projected vertices and the first vertex. This produces an average vertex indicated by avg_m_{1_1}. Mathematically this is presented as:

$$a v g {m}_{1 \_ 1} = \frac{{m}_{1 \_ 1} + {p}_{2} {m}_{1 \_ 1} + {p}_{3} {m}_{1 \_ 1}}{3}$$

6) The next step is to compute a deviation vector formed between the mesh vertex and the averaged mesh vertex. This is obtained by subtracting the mesh vertex from the average mesh vertex and it produces: devm_{1_1}=avgm_{1_1}−m_{1_1}.

7) With reference to FIG. 19F, the next step is to determine which cube the deviation vector devm_{1_1} resides in (in the example, it is the same as the cube where m_{1_1} resides). For the 8 nodes (corners of the cube in 3D and corners of the box in 2D) the barycentric weighting factor for each node is computed. This node-specific barycentric factor is then multiplied by the deviation vector to get a weighted deviation vector for that vertex and that node. This is referred to as B_{1_1}devm_{1_1}. Each barycentric factor is a number between 0 and 1.0. If a mesh vertex is closer to one node than other nodes, then that node's barycentric weighting factor will be larger. The sum of the barycentric weighting factors will be 1.

8) When all the mesh vertices are processed there will be some number of barycentric weighted deviation vectors at each node. Some nodes may have no vectors while others may have many. The next step is to average the vectors that are there to produce an average deviation vector for that node. At this point all the individual vertex contributions have been averaged together so the vector at each node is referred to as avg_{1_1}dev, or the average for N_{1_1} of the deviation vector. When some mesh vertices are projected onto the other meshes, they may miss or hit a location that is deemed to be too far away. In this case the vertex is discarded from the computation.

9) At this point there are some nodes with averaged deviation vectors and some without. The nodes without deviation vectors need to be filled via a volumetric filling scheme. For any node that is missing a deviation vector, an equation is written that defines the value as a linear combination of its neighboring values. For the X nodes that have missing values this will produce a set of X equations of X unknown vectors. By solving the linear system of equations we can fill in the missing node values.

10) Once the average deviation vector (e.g. avg_{1_1}dev) at each node is calculated, we go back to the mesh vertex m_{1_1} and move it by a barycentric weighted average of the deviation vectors at the nodes of the cube containing the mesh vertex. This means that the average deviation vectors at the nodes are themselves averaged together as a group using barycentric weighting. If the mesh vertex m_{1_1} is closer to one of the nodes than the others, then the system will give higher weighting to that node's average deviation vector. The result of this average is called adjm_{1_1} which stands for the adjusted vertex m_{1_1}.

11) At the end of step 10, all vertices in the first mesh have been processed and these vertices will have been moved in the directions towards the other meshes—as represented by the adjusted vertex positions in FIG. 19G. Steps 1-10 are then repeated for the second and then third mesh—this time moving the vertices of mesh2 and mesh3. When the next mesh is processed, the adjusted positions from the first mesh are used and when the third mesh is processed, the adjusted positions of the vertices from the first two meshes are used.

12) When all meshes have been processed once, steps 1-11 are processed again using the adjusted positions of all meshes as a starting point. Step 12 is repeated up to 20 times in order to reach a convergence where the vertices of the various meshes move towards the collective average of the other meshes.

13) With reference to FIG. 19H, once all meshes have been processed in this manner, the first mesh is averaged against the others and then the first mesh is used as the composite mesh—or composite scan in the case the meshes are scans. For each vertex of the first mesh, the vertex is projected onto the second and third meshes and then the average of the first vertex and the other projected vertices is computed. This averaged vertex then replaces the first vertex.

Scan Adjustment Using the Mesh Registration Mechanism

1) For scan adjustment, the process starts with obtaining some number of scans. These scans are positioned relative to each other first using a PCL (point cloud library) which rotates and translates the scans until they optimally fit to each other. This is a known fitting algorithm.

2) The scans are then processed using the mesh registration mechanism described above. This results in the first scan being a composite scan.

3) The composite scan is then aligned to the part mesh using the approach in step 1 of the process described above.

4) Next, the mesh registration process is applied to the part mesh and the composite scan mesh. The only difference in the approach is when the composite scan mesh is processed at step 10. At step 10) the composite scan mesh vertices are not moved to their adjusted positions using the barycentric weighted average deviation vectors avg_{2_1}dev. Here, the _{2_1} refers to the second mesh first node (the composite scan in this case). Instead, the part mesh vertices falling within this same grid cube with corner nodes are moved in the opposite direction by the weighted average deviation vectors avg_{2_1}dev. What this means is that instead of adjusting the composite scan vertices towards the part mesh vertices, instead the part mesh vertices are moved towards the composite scan mesh vertices. So during the entire part to composite mesh registration process the process is always moving the part mesh vertices towards the composite scan mesh vertices—since it is more important for the part mesh to end up looking like the composite scan mesh.

5) Once the part mesh to composite scan mesh registration process has been completed, there is a part mesh whose vertices have been moved by the scan adjustment amount towards the scan. For each part mesh vertex there is an adjusted part mesh vertex, and the delta vector is the scan adjustment amount for that vertex.

6) The last step is to apply the scan adjusted delta vectors to a different and independent set of negative offset vectors that represent how the part mesh was scaled up and counter-warped to counteract sintering, swelling, or another transformative process.

7) The present disclosure involves taking a part mesh and constructing a cell mesh with a different coarseness, and then transforming the shape of the cell mesh to mimic scaling up and counter warping to offset shrinkage, swelling, and other distortion producing processes. In the disclosed method, each cell mesh particle is associated with a negative offset vector. So, when the part is to be exported, the negative offset vectors are used to modify the part mesh and this is exported for printing and sintering.

8) Scan adjustment vectors are applied that are associated with the part mesh as follows. Each cell mesh particle is projected onto the nearest part mesh triangle. The three vertices of this triangle are used to look up the three scan adjustment vectors. A barycentric weighting of these scan adjustment vectors is computed using the position of the projected cell mesh particle on the triangle of the part mesh. Finally, the negative of the averaged scan adjustment vector is multiplied by a scale up factor and the final vector is added to the negative offset vector associated with this cell mesh particle. The effect of this process is to move the negative offset vector in the opposite direction of the scan adjustment vector. For example, if the scan adjustment vector was pointing downwards, indicating that the mesh was below the part (i.e. it had sagged down too far) then the negative offset vector would be moved upwards to compensate for this error. The next time the part is printed using the scan adjusted negative offset vector, it will be higher in this location and will sinter and warp to a position higher and closer too the part position.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this invention, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this invention, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions but also data structures, data stores and computing instructions stored in any suitable electronic format, including firm ware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It is intended that the specification and examples be considered as exemplary only.

What is claimed:

1. A method of compensating for shrinking and distortion of an object resulting from a manufacturing process, comprising:
performing at least one scan of at least one object following a manufacturing process to produce scan data;
aligning the scan data to a part mesh of the object;
adjusting the part mesh to substantially coincide with the scan data by moving part mesh vertices;
computing delta vectors by subtracting initial part mesh vertex positions from final part mesh vertex positions; and
applying the inverse of the delta vectors to a pre-processed part mesh to give a scan adjusted pre-processed shape.

2. The method of claim 1 wherein the preprocessed part mesh is at least one of scaled or counter-distorted for an anticipated shrinkage or warpage caused by sintering.

3. The method of claim 1 wherein the step of computing delta vectors includes:
superimposing a volume cubic grid over the part mesh, each corner of the volume cubic grid being a node;
computing a barycentric weighting factor for each node and multiplying each barycentric weighting factor by its associated delta vectors to produce a set of weighted delta vectors,
averaging the weighted delta vectors for each node to produce a set of averaged weighted delta vectors,
assigning any nodes missing averaged weighting delta vectors an averaged weighted delta vector based on the averaged delta vectors of surrounding nodes; and
wherein the step of applying the inverse of the delta vectors includes adjusting the part mesh according to the weighted delta vectors for each node of the associated volume cubic grid.

4. The method of claim 1 wherein the at least one scan is multiple scans.

5. The method of claim 4 further comprising the step of, prior to aligning the scan data to a part mesh of the object, mesh registering the multiple scans to one another.

6. The method of claim 5 wherein the at least one object is multiple objects.

7. The method of claim 1 wherein the step of computing delta vectors includes a scaling transformation.

8. The method of claim 1 wherein the scan data includes an estimation of features not visible in the scan.

9. A method of compensating for shrinking and distortion of an additively manufactured part caused by a sintering process, comprising:
receiving a design shape of the part;
applying a pre-process transformation to the design shape to create a pre-process shape of the part;
additively manufacturing an evaluation part according to the pre-process shape of the part;
subjecting the additively manufactured evaluation part to a sintering process;
conducting and averaging a plurality of scans of the evaluation part to determine a deviation profile;
determining a volumetric deformation map from the deviation profile and adjusting the pre-process shape of the part according to the volumetric deformation map to produce a production shape of the part; and
additively manufacturing the part according to the production shape of the part.

10. The method of claim 9 wherein the step of determining the volumetric deformation map includes smoothing an amount of surface noise in the deviation profile.

11. The method of claim 9 wherein the step of determining the volumetric deformation map includes adjusting for at least one internal feature not observable via conducting the plurality of scans.

12. The method of claim 9 wherein the design shape of the part includes a selection of at least one surface for which deformation is not desired, and, not deforming the selected surfaces during the step of applying the pre-process transformation.

13. The method of claim 9 further comprising not deforming the selected surfaces during the step of adjusting the pre-process shape according to the volumetric deformation map.

14. The method of claim 9 wherein the pre-process transformation includes applying an anisotropic scaling process.

15. The method of claim 9 wherein the pre-process transformation includes applying a negative offset of at least a portion of the part.

16. The method of claim 9 wherein the distortion map includes vectors to corresponding points on the pre-process shape.

17. The method of claim 9 wherein the plurality of scans includes at least one computed tomography (CAT) scan.

18. The method of claim 9 wherein the step of averaging the plurality of scans includes positioning the plurality of scans with respect to each other to minimize registration errors.

19. The method of claim 9 wherein the step of averaging the plurality of scans includes aligning a plurality of meshes of the scans by computing the principal axis of each scan and rotating the respective meshes to align the principle axis.

20. The method of claim 9 wherein after the step of aligning the plurality of meshes of the scans, aligning the plurality of meshes using an iterative closest point algorithm.
